(19) United States
(12) Patent Application Publication
(10) Pub. No.: US 2026/0141893 A1
(43) Pub. Date: May 21, 2026

(54) ON-DEVICE TEXT-TO-SPEECH MODEL PERSONALIZATION

(71) Applicant: QUALCOMM Incorporated, San Diego, CA (US)

(72) Inventors: Yoonhyung LEE, Goyang-si (KR); Jaeseong YOU, Seoul (KR); Jinkyu LEE, Seoul (KR); Seunghan YANG, Incheon (KR)

(21) Appl. No.: 18/951,356

(22) Filed: Nov. 18, 2024

(51) Int. Cl. G10L 15/06

(52) U.S. Cl. CPC G10L 15/063; G10L 2015/0636

(57) ABSTRACT

A device includes a memory configured to store a set of speech samples and one or more processors coupled to the memory. The one or more processors are configured to obtain, during normal operation of the device, one or more audio signals that include user speech and perform a sequence of sample criteria checks on the speech samples associated with the one or more audio signals. The sequence of sample criteria checks includes a check whether a confidence value associated with an automatic speech recognition (ASR) transcription of a sample exceeds a transcription confidence threshold. The sequence of sample criteria checks also includes a check whether a loss value associated with a personalized text-to-speech (TTS) output of the sample exceeds a loss threshold, whether the ASR transcription satisfies a lexicon diversity criterion, or both.

### I. FIELD

The present disclosure is generally related to speech sample processing for a text-to-speech model.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to receive an audio signal from one or more microphones. For example, the audio signal may represent user speech captured by the microphones, external sounds captured by the microphones, or a combination thereof. Such devices may include an audiobook reader application or a personal assistant application that benefit from personalized text-to-speech processing. For example, an audiobook reading application may playout audio associated with an audiobook that, instead of being based on a pre-recorded voice of another person, is closer to a user's voice and has the user's vocal characteristics. Similarly, a personal assistant application may output audio associated with a user's calendar, an answer to a question, or messages of the user, and the audio may resemble the user's voice and vocal characteristics. Such personalized audio may improve user understanding of the information provided by the audio, and thus improve user experience. Although text-to-speech models can be trained to more closely match user voice and user vocal characteristics, such training typically involves several hours of speech samples and fine tuning, as well as significant computation resources. Typical user devices, such as smart phones, wearable electronic devices, and the like, lack the processing and memory resources to support such training, and thus rely on providing audio samples to a server or cloud-based system to perform the model training, which can introduce security and privacy issues as well as increases latency in a network.

### III. SUMMARY

According to one implementation of the present disclosure, a device includes a memory configured to store a set of speech samples. The device also includes one or more processors coupled to the memory. The one or more processors are configured to obtain, during normal operation of the device, one or more audio signals that include user speech. The one or more processors are also configured to perform a sequence of sample criteria checks on the speech samples associated with the one or more audio signals. The sequence of sample criteria checks includes a check whether a confidence value associated with an automatic speech recognition (ASR) transcription of a sample exceeds a transcription confidence threshold. The sequence of sample criteria checks also includes a check whether a loss value associated with a personalized text-to-speech (TTS) output of the sample exceeds a loss threshold, the ASR transcription satisfies a lexicon diversity criterion, or both.

According to another implementation of the present disclosure, a method includes obtaining, by one or more processors of a device during normal operation of the device, one or more audio signals that include user speech. The method also includes performing, by the one or more processors, a sequence of sample criteria checks on speech samples associated with the one or more audio signals. The sequence of sample criteria checks includes a check whether a confidence value associated with an automatic speech recognition (ASR) transcription of a sample exceeds a transcription confidence threshold. The sequence of sample criteria checks also includes a check whether a loss value associated with a personalized text-to-speech (TTS) output of the sample exceeds a loss threshold, the ASR transcription satisfies a lexicon diversity criterion, or both.

According to another implementation of the present disclosure, a non-transitory computer-readable medium stores instructions that are executable by one or more processors to cause the one or more processors to obtain, during normal operation of a device, one or more audio signals that include user speech. The instructions further cause the one or more processors to perform a sequence of sample criteria checks on speech samples associated with the one or more audio signals. The sequence of sample criteria checks includes a check whether a confidence value associated with an automatic speech recognition (ASR) transcription of a sample exceeds a transcription confidence threshold. The sequence of sample criteria checks also includes a check whether a loss value associated with a personalized text-to-speech (TTS) output of the sample exceeds a loss threshold, the ASR transcription satisfies a lexicon diversity criterion, or both.

According to another implementation of the present disclosure, an apparatus includes means for obtaining, during normal operation of a device, one or more audio signals that include user speech. The apparatus also includes means for performing a sequence of sample criteria checks on speech samples associated with the one or more audio signals. The sequence of sample criteria checks includes a check whether a confidence value associated with an automatic speech recognition (ASR) transcription of a sample exceeds a transcription confidence threshold. The sequence of sample criteria checks also includes a check whether a loss value associated with a personalized text-to-speech (TTS) output of the sample exceeds a loss threshold, the ASR transcription satisfies a lexicon diversity criterion, or both.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system including a device operable to support on-device speech sample generation for a personalized text-to-speech (TTS) model, in accordance with one or more aspects of the present disclosure.

FIGS. 2A and 2B are a diagram of an example of a method performed by the device of FIG. 1, in accordance with one or more aspects of the present disclosure.

FIG. 3 is a diagram of an example of an integrated circuit operable to support on-device speech sample generation for a personalized TTS model, in accordance with some examples of the present disclosure.

FIG. 4 is a diagram of a mobile device operable to support on-device speech sample generation for a personalized TTS model, in accordance with some examples of the present disclosure.

FIG. 5 is a diagram of a headset operable to support on-device speech sample generation for a personalized TTS model, in accordance with some examples of the present disclosure.

FIG. 6 is a diagram of a wearable electronic device operable to support on-device speech sample generation for a personalized TTS model, in accordance with some examples of the present disclosure.

FIG. 7 is a diagram of a voice-controlled speaker system operable to support on-device speech sample generation for a personalized TTS model, in accordance with some examples of the present disclosure.

FIG. 8 is a diagram of earbuds operable to support on-device speech sample generation for a personalized TTS model, in accordance with some examples of the present disclosure.

FIG. 9 is a diagram of an example of a vehicle operable to support on-device speech sample generation for a personalized TTS model, in accordance with some examples of the present disclosure.

FIG. 10 is a diagram of an example of a method of on-device speech sample generation for a personalized TTS model, in accordance with some aspects of the present disclosure.

FIG. 11 is a block diagram of an illustrative example of a device that is operable to support on-device speech sample generation for a personalized TTS model, in accordance with one or more aspects of the present disclosure.

### V. DETAILED DESCRIPTION

Typically, a language application, such as an audiobook reader application or a personal assistant application, uses a text-to-speech (TTS) model to generate and output synthetic speech to a user. TTS models are typically trained by providing a large corpus of speech samples as training data, with such speech samples being based on speech of a different person than the user. The training of the TTS model typically occurs before the TTS model is deployed to the end user device, such as a smart phone, a wearable electronic device, or the like, because of the significant computational resources used in the training process. Because the training is performed before a user initially utilizes the speech application, the training does not include speech of the user themself, and as such the synthetic speech output by the TTS model may have a different person's voice or vocal characteristics instead of the those of the user. This not only degrades the user experience of personalized TTS, the user may also find it challenging to understand some output audio that is related to different pronunciations or speech characteristics from those that are specific to the user's unique vocal traits. Some TTS models can be trained to be more personalized to a particular user, for example by being trained based on speech samples from the particular user. For example, a zero-shot TTS model may condition a speaker-agnostic TTS model with a speaker embedding from a speaker encoding that is derived from the user, or a few-shot TTS model may fine tune part of the TTS model based on speech samples from the user.

However, acquiring such speech samples having sufficient quality and that include words or phrases that are commonly said by the user can be challenging, especially if the user frequently uses technical jargon or other relatively uncommon words and phrases. One solution is to have the user record themselves speaking training phrases with the speech application. However, improving the quality and personalization of a TTS model can require fine tuning using several hours of speech, which can be overly burdensome to the user. Additionally, the training phrases will often be selected from the overall most common words and phrases used by a large quantity of users, such that the training phrases fail to include particular technical jargon that is frequently used by a particular user. To overcome these difficulties, the bulk of the training, even for personalized TTS models, is done on the network side using speech samples recorded by others reading a large volume of training phrases. Although off-device training has the benefit of more processing and computing resources for the training and a large volume of training samples, off-device training has drawbacks with regard to personalized TTS models. To illustrate, personally recorded samples from the user must be provided from the user device to the network (or other training location), which can increase network overhead as well as introduce data privacy and security issues.

Systems and methods of supporting on-device speech sample generation for training or adaptation of a personalized TTS model are disclosed. In an example, a model trainer obtains audio samples of user speech during normal operation of a device, such as during phone calls, during operation of a speech application, or by periodically monitoring one or more microphones. In some embodiments, to provide high quality speech samples that are relevant for training the personalized TTS model and to reduce or minimize the use of limited training resources on a target device, the model trainer may discard speech samples that include speech of another person (e.g., not speech of the user), in addition or in the alternative to performing noise reduction and other filtering operations on the user speech samples. The model trainer performs a sequence of sample criteria checks on the user speech samples to generate a set of training samples to be used to train the personalized TTS model, with user speech samples that fail one or more of the criteria checks being discarded. To illustrate, the criteria checks may include a check whether a confidence value associated with an automatic speech recognition (ASR) transcription of a sample exceeds a transcription confidence threshold, a check whether a loss value associated with a personalized TTS output of the sample exceeds a loss threshold, the ASR transcription satisfies a lexicon diversity criterion, or both, a check whether a signal-to-noise ratio (SNR) value associated with the sample exceeds an SNR threshold, or a combination thereof. The set of training samples, after passing the various criteria checks, may be stored as a training corpus and used to train a TTS model to be more personalized to the user (e.g., to have a voice and vocal characteristics that are more similar to the user) when a trigger condition is detected. The trigger condition may be configured to enable training of the TTS model when the user device is not being used, such as when the user is asleep, or when the user device is plugged into an external power source, as non-limiting examples. In addition, or in the alternative, to initially training a personalized TTS model, some aspects disclosed herein enable on-device adaptation of an existing TTS model to become personalized to the user of the device based on the speech samples that pass the sequence of sample criteria checks described herein.

The systems and methods disclosed herein provide one or more technical benefits as compared to other systems for training personalized TTS models. To illustrate, the techniques described herein enable training or adapting of a TTS model that mimics the voice and vocal characteristics of the user in a more convenient and less obtrusive manner than other personalized TTS model training. For example, using the disclosed techniques, a generic TTS model, or even a zero-shot or few-shot personalized TTS model, may be trained to improve user personalization using speech samples that are generated without requiring the user to record themselves speaking a large volume of training samples. Additionally, because the speech samples are collected during normal operation of the user device, the speech samples are more likely to include frequently used words and phrases that are specific to the user, such as technical jargons, particular languages, etc., that may not be broadly applicable enough to be included in conventional training sample sets. The speech samples are chosen, through the use of multiple criteria checks, to improve or maximize the effectiveness of the training in view of the limited training resources of some target devices.

Additionally, by performing the criteria checks herein on input user speech samples in order to select a subset of the samples to be used as a training corpus, the techniques described herein enable training or adaptation based on speech samples having good quality and that most likely to provide benefit to improving the personalization of the TTS model. For example, speech samples that have a high likelihood of providing valuable training information may be indicated by a loss value that is based on a comparison between an input speech sample and a speech sample output by the TTS model based on the same underlying text. As another example, speech samples that have a high likelihood of providing valuable training information may be indicated by a difference in lexicon diversity between the input sample and a previous training corpus. Additionally, or alternatively, aspects disclosed herein enable training or adapting of the personalized TTS model to be performed on-device, thereby avoiding data privacy or security issues and increased network overhead associated with sharing the user speech samples with another device for off-device training of the TTS model.

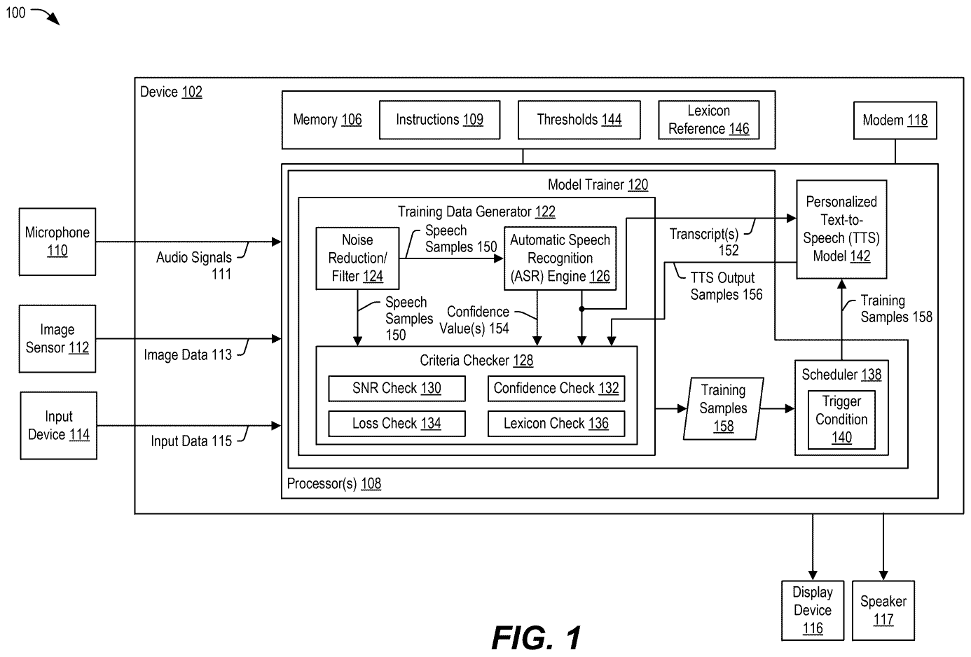

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter. For example, referring to FIG. 8, multiple speakers are illustrated and associated with reference numbers 806A and 806B. When referring to a particular one of these speakers, such as a speaker 806A, the distinguishing letter “A” is used. However, when referring to any arbitrary one of these speakers or to these speakers as a group, the reference number 806 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or fine-tuned) using a machine-learning technique. In this context, “training” refers to adapting the model or parameters of the model to a particular data set. Unless otherwise clear from the specific context, the term “training” as used herein includes “fine-tuning” or refining a model for a specific data set. In fine-tuning, a base model may initially be trained using a generic or typical data set, and the base model may be subsequently refined (e.g., further trained) using a more specific data set. Additionally, the term “adapting” as used herein includes “fine-tuning” or refining an existing model for a specific data set not used during the initial training of the model. The adapting can include re-training, modifying one or more model parameters or hyperparameters, or otherwise optimizing the model for performance associated with the specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system including a device 102 operable to support on-device speech sample generation for a personalized TTS model 142, in accordance with one or more aspects of the present disclosure. The system 100 includes the device 102 that is configured to generate speech samples for use in on-device training of the personalized TTS model 142 (e.g., without transmitting speech samples to another device, such as a server or cloud-based system, for off-device training), as further described below. Additionally, or alternatively, the device 102 is configured to adapt an existing TTS model to perform as a perform as a personalized TTS model, or to improve the personalized performance of an existing personalized TTS model. As such, the operations described below with reference to training the personalized TTS model 142 may also or alternatively be performed to adapt the personalized TTS model 142 from an already-existing TTS model.

The device 102 includes, or is coupled to, a memory 106, one or more processors 108 (collectively referred to herein as the “processor 108”), a microphone 110, an image sensor 112, an input device 114, a display device 116, a speaker 117, and a modem 118. The memory 106 may include one or more memory devices, such as a single memory device or multiple different memory devices (of the same type or of different types). The memory 106 is configured to store instructions 109, thresholds 144, and a lexicon reference 146. The thresholds 144 include multiple types of thresholds associated with performance of a sequence of criteria checks on speech samples to determine whether to discard the speech samples or to include the speech samples in a training set, as further described below. The lexicon reference 146 includes a reference vocabulary or other collection of lexicon data to compare to a transcription generated based on one or more samples under test to determine whether a lexicon diversity criteria is satisfied, as further described below. In some examples, the lexicon reference 146 includes a transcription of at least some speech samples used as training data for the personalized TTS model 142 during a previous training session. Additionally, or alternatively, the lexicon reference 146 can include a list of target words, phrases, or the like, that are frequently used by a user of the device 102 or for which the personalized TTS model 142 is to be personalized to sound more like the user.

In some examples, the memory 106 further includes or stores the instructions 109 that, when executed by the processor 108, cause the processor 108 to perform one or more operations as described herein. In some examples, the memory 106 stores other information or data, such as other references, other thresholds or criteria, additional speech samples (e.g., samples that may be used for additional training), training results (e.g., quantity of samples in a training set, computed confidence values, loss values, or the like) associated with training the personalized TTS model 142, model data (e.g., parameters used to implement an instance of the personalized TTS model 142), one or more settings, other information, or a combination thereof.

The processor 108 includes a model trainer 120 and the personalized TTS model 142. Each of the model trainer 120 and the personalized TTS model 142, or a portion thereof, may be implemented by the processor 108 executing instructions (e.g., software), dedicated hardware (e.g., circuitry), a combination thereof. Although illustrated as being included in the processor 108, in other examples, the personalized TTS model 142 may be represented by model data (e.g., parameters, hyperparameters, etc.) that is stored in the memory 106. The model trainer 120 is configured to manage training of the personalized TTS model 142. The personalized TTS model 142 includes a text-to-speech model that is trained to output synthetic speech that is based on input data (e.g., text data or text features) and that is “personalized” such that the synthetic speech is similar in voice and vocal characteristics to speech of a user of the device 102. In some embodiments, the personalized TTS model 142 includes an end-to-end speech synthesis model that is based on variational inference with adversarial learning for end-to-end speech synthesis (VITS). Although described as a personalized model, in some examples, the personalized TTS model 142 is not personalized, or is not as highly personalized, until performance of the training process described further herein. For example, prior to training, the personalized TTS model 142 may include a zero-shot TTS model that is trained to perform TTS conversion but that is not trained for any particular user. As another example, prior to the training, the personalized TTS model 142 may be a few-shot TTS model that is trained for the user of the device 102, although the personalized TTS model 142 may benefit from additional training for personalization, particularly with relation to uncommon words and phrases that are frequently used by the user, such as technical jargons, detailed reference materials, career-specific vocabularies, or the like, as well as words or phrases that include or that are based on other languages (e.g., language(s) for which the personalized TTS model 142 has not been trained).

The model trainer 120 is configured to generate a set of training samples to be used to train the personalized TTS model 142 and, in some embodiments, to schedule and manage the training of the personalized TTS model 142. In the illustrated example, the model trainer 120 includes a training data generator 122 that is configured to generate the set of training samples and a scheduler 138 that is configured to schedule and manage performance of the training for the personalized TTS model 142. The training data generator 122 is configured to process input audio samples to generate speech samples 150 from which training samples 158 may be selected (e.g., based on performance of a sequence of criteria checks). The training samples 158 may be stored at the memory 106 and provided to the scheduler 138 for use in training the personalized TTS model 142, as further described below.

In the example shown in FIG. 1, the training data generator 122 includes a noise reduction/filter 124, an automatic speech recognition (ASR) engine 126, and a criteria checker 128. In other embodiments, one or more of the elements 124-128 may be combined or omitted from the training data generator 122. The training data generator 122 is configured to perform a training sample generation process, and the elements 124-128 are configured to perform portions of the process. To illustrate, the noise reduction/filter 124 is configured to perform noise reduction on input audio samples, to perform user filtering on the input audio samples (e.g., the filter the samples that do not include speech of the user of the device 102), or both. For example, the noise reduction/filter 124 may be configured to perform one or more noise reduction operations on audio samples obtained based on audio signals 111 generated by the microphone 110 to generate the speech samples 150. Additionally, or alternatively, the noise reduction/filter 124 may be configured to perform one or more filtering operations on the audio samples to filter out samples that do not include speech of the user of the device 102. To illustrate, the noise reduction/filter 124 may perform one or more speech analysis operations on each input audio sample and, if the input audio sample includes speech of the user of the device 102, the noise reduction/filter 124 outputs the audio sample as one of the speech samples 150. However, if the input audio sample includes speech of other people that are not the user of the device 102, the noise reduction/filter 124 discards the input audio sample. As such, the speech samples 150 may include samples of speech of the user of the device 102 with reduced or eliminated noise components. The noise reduction/filter 124 outputs the speech samples 150 to the ASR engine 126 and to the criteria checker 128 for additional operations of the training sample generation process.

The ASR engine 126 is configured to perform ASR on the speech samples 150 to generate one or more ASR transcript(s) 152 (e.g., transcriptions) that include text that represents the user speech of the speech samples 150 and one or more confidence value(s) 154 that represent confidence score(s) associated with the ASR transcript(s) 152 (e.g., a rating of how likely the ASR transcript(s) 152 match the speech samples 150). To illustrate, the ASR engine 126 may include an ASR model that is trained to output a transcript or transcription based on input speech samples (e.g., the ASR model is configured to generate text that represents the words, phrases, and/or sentences included in the speech of the speech samples 150) and a confidence value that indicates a score computed by the ASR model to represent how likely the transcript matches the speech samples. In the example shown in FIG. 1, the ASR engine 126 is configured to generate the ASR transcript(s) 152 based on the speech samples 150 in addition to the confidence value(s) 154 that represent the confidence that the ASR transcript(s) 152 match the speech samples 150. The ASR engine 126 may provide the ASR transcript(s) 152 to the personalized TTS model 142 for generating one or more synthetic speech outputs, as further described below. Additionally, the ASR engine 126 may provide the ASR transcript(s) 152 and the confidence value(s) 154 to the criteria checker 128 for additional operations of the training sample generation process.

The criteria checker 128 is configured to perform a sequence of criteria checks on the speech samples 150 to generate the training samples 158. For example, the criteria checker 128 performs one or more measurements, calculations, comparisons, or determinations based on the speech samples 150 and one or more of the ASR transcript(s) 152, the confidence value(s) 154, synthetic speech samples received from the personalized TTS model 142 (e.g., TTS output samples 156), the thresholds 144, and the lexicon reference 146 as part of the sequence of criteria checks, and the criteria checker 128 is configured to discard one or more of the speech samples 150 based on results of the sequence of criteria checks. To illustrate, the criteria checker 128 may discard a sample under test of the speech samples 150 that fails one or more of the sequence of criteria checks, and the remaining samples of the speech samples 150 may be output as the training samples 158. Each criteria check may include one or more comparisons, determinations, or the like, as further described herein. Thus, the training samples 158 represent samples of the speech samples 150 that satisfy the sequence of criteria checks performed by the criteria checker 128. The criteria checker 128 may store the training samples 158 at the memory 106, provide the training samples 158 to the scheduler 138 for training the personalized TTS model 142, or both.

In the example illustrated in FIG. 1, the sequence of criteria checks performed by the criteria checker 128 includes a signal-to-noise ratio (SNR) check 130, a confidence check 132, a loss check 134, and a lexicon check 136. In other examples, the sequence of criteria checks may omit one of the criteria checks 130-136 or may include more or different criteria checks than shown in FIG. 1. As such, one or more of the criteria checks 130-136 may be optional and, in some examples, be omitted from the sequence of criteria checks. In a particular example, the sequence of criteria checks is performed in the following order: the SNR check 130, followed by the confidence check 132, followed by the loss check 134 and the lexicon check 136 (e.g., either sequentially or in parallel). Although the criteria checks 130-136 are described as being performed in a particular order, in other embodiments, the sequence of criteria checks may be performed in a different order.

It is noted that the criteria checks 130-136 are described as being satisfied if a value “exceeds” a respective threshold (or when the value is greater than or equal to the threshold), however, this is only one example of satisfying the threshold. Any or all of the comparisons could be logically equivalent to another value that satisfies a threshold when it is less than (or less than or equal to) the respective threshold. As an illustrative example, a similarity metric exceeding a similarity threshold can be functionally equivalent to a difference metric failing to exceed (e.g., being less than) a difference threshold. As another example, a confidence value exceeding a confidence threshold can be functionally equivalent to an uncertainty value failing to exceed the confidence threshold. As such, the comparison that corresponds to satisfying a criterion may be a design choice.

The SNR check 130 includes a comparison of a SNR associated with the speech samples 150 to a SNR threshold of the thresholds 144. For example, the criteria checker 128 may estimate, or measure, an SNR associated with a sample under test of the speech samples 150, and the SNR check 130 is passed (or failed) based on whether the SNR exceeds (or fails to exceed) the SNR threshold. The confidence check 132 includes a comparison of the confidence value(s) 154 to a confidence threshold of the thresholds 144. For example, the criteria checker 128 may compare the confidence value(s) 154 associated with a sample under test of the speech samples 150 to the confidence threshold, and the confidence check 132 is passed (or failed) based on whether the confidence value(s) 154 exceeds (or fails to exceed) the confidence threshold.

The loss check 134 includes a comparison of a loss based on the speech samples 150 and synthetic speech samples (e.g., the TTS output samples 156) to a loss threshold of the thresholds 144. For example, the criteria checker 128 may determine a loss value associated with a sample under test of the speech samples 150 based on a comparison of the sample under test and a corresponding one of the TTS output samples 156, which are generated by the personalized TTS model 142 based on the ASR transcript(s) 152. In this example, the loss check 134 is passed (or failed) based on whether the loss value exceeds (or fails to exceed) the loss threshold. The lexicon check 136 includes a determination of whether a lexicon diversity between the ASR transcript(s) 152 and the lexicon reference 146 satisfies a diversity criteria of the thresholds 144. For example, the criteria checker 128 may determine a lexicon diversity based on a comparison of the lexicon check 136 to the lexicon reference 146, and the lexicon check 136 is passed (or failed) based on whether the lexicon diversity satisfies (or fails to satisfy) the diversity criteria. In some embodiments, the lexicon reference 146 includes a previous training corpus used to train the personalized TTS model 142 and the lexicon diversity criteria corresponds to exceeding a diversity threshold (e.g., such that the speech samples 150 include words or phrases for which the personalized TTS model 142 has not been trained or has only been trained a few times). In some other embodiments, the lexicon reference 146 includes a target lexicon, such as a vocabulary associated with a user-selected technical jargon, career field, regional dialect, language, or the like, and the lexicon diversity criteria corresponds to failing to exceed a diversity threshold (e.g., such that the speech samples 150 include words or phrases of the target lexicon). Although illustrated as individual checks, in some embodiments, the criteria checker 128 may be configured to retain a sample under test that passes either the loss check 134 or the lexicon check 136, such that discarded samples fail both the loss check 134 and the lexicon check 136.

The scheduler 138 is configured to schedule and manage training for the personalized TTS model 142. In some embodiments, the personalized TTS model 142 is trained at particular times or in response to particular conditions that correspond to the device 102 not being used or having more available computing resources to use for the training. To illustrate, the scheduler 138 is configured to monitor for a trigger condition 140 and, based on detection of the trigger condition 140, initiate training of the personalized TTS model 142 using the training samples 158. The trigger condition 140 may be based on a time of day, an activity level associated with the device 102, a power status associated with the device 102, one or more settings, other conditions, or a combination thereof. For example, the trigger condition 140 may include a time period when the user of the device 102 is asleep, which may be determined based on a calendar application executed at the device 102, historical device use (e.g., long periods of inactivity detected during similar time periods over multiple days or weeks), an operating mode of the device 102 (e.g., a sleep mode, an inactive mode, etc.), or a combination thereof. As another example, the trigger condition 140 may include the device 102 being connected to an external power source or that a power level associated with a battery of the device 102 exceeds a power threshold. As another example, the trigger condition 140 may include detection of a particular time or condition indicated by one or more settings, such as a user-configured training setting.

In some embodiments, upon detection of the trigger condition 140, the scheduler 138 may cause training of the personalized TTS model 142 using the training samples 158 until the training is complete. In some other embodiments, if the trigger condition 140 is no longer detected before completion of the training, the scheduler 138 may pause or terminate the training and store the portion of the training samples 158 that were unable to be used for a future training session. In some other embodiments, based on detection of the trigger condition 140, the scheduler 138 may estimate a training time period needed to train the personalized TTS model 142 using the training samples 158 and, if the estimated training time is less than an estimated duration of the trigger condition 140, the scheduler 138 initiates the training of the personalized TTS model 142. If the estimated training time exceeds the estimated duration of the trigger condition 140, the scheduler 138 may refrain from training the personalized TTS model 142 and wait until another detection of the trigger condition 140. In such embodiments, if the scheduler 138 refrains from training the personalized TTS model 142 for a threshold number of detections of the trigger condition 140, the scheduler 138 may initiate the training based on the next detection of the trigger condition 140, regardless of whether the estimated training time is less than the estimated duration of the trigger condition 140.

The modem 118 is coupled to the processor 108 and is configured to transmit data to one or more other devices (e.g., via one or more networks). For example, the data transmitted by the modem 118 may include trained model data (e.g., parameters of the personalized TTS model 142 after at least some on-device training has been performed). In some embodiments, the modem 118 may be configured to receive data from another device. For example, the data received by the modem 118 may include model data (e.g., parameters of a pre-trained model, or a less-personalized model, used to implement the personalized TTS model 142), the thresholds 144, the lexicon reference 146, speech samples of the user collected by another device, or a combination thereof.

The processor 108 is also coupled to the microphone 110, the image sensor 112, the input device 114 (e.g., another microphone, a keyboard or touch screen, etc.), the display device 116, and the speaker 117. The microphone 110 may include one or more microphones (e.g., audio capture device(s)) and be configured to generate the audio signals 111, such as audio data that represents user speech recorded during normal operation of the device 102. For example, the audio signals 111 may represent user speech associated with a phone call, user speech associated with interactions with a speech application, user speech recorded during periodic audio capturing, other user speech, or a combination thereof. The image sensor 112 may include one or more cameras and may be configured to generate image data 113, such as one or more images or video frames associated with a multimedia call. The input device 114 is configured to receive an input and provide the input to the processor 108 as input data 115. For example, the input device 114 may include a keyboard, a touch screen, or a microphone configured to receive the input (e.g., a user input) and provide the input data 115 (e.g., an input signal) to the processor 108, such as a user setting to schedule training of the personalized TTS model 142.

The display device 116 is coupled to the processor 108 and is configured to output visual outputs for display to a user, such as images or video associated with a phone call or a multimedia call, results of one or more sessions of training the personalized TTS model 142, one or more user interfaces (UIs) associated with requesting authorization or providing results associated with training the personalized TTS model 142, or a combination thereof. In some examples, the display device 116 includes a display screen, a monitor or television, a projector, or a combination thereof. The speaker 117 includes one or more speakers coupled to the processor 108 and is configured to output audio to the user, such as audio associated with a phone call or a multimedia call, audio generated by a speech application (e.g., synthetic speech generated by the personalized TTS model 142), other audio, or a combination thereof.

The microphone 110, the image sensor 112, the input device 114, the display device 116, the speaker 117, or a combination thereof, may be coupled to or integrated within the device 102. In some implementations, one or more of the microphone 110, the image sensor 112, the input device 114, the display device 116, or the speaker 117 may be included in another device that is coupled (e.g., communicatively coupled) to the device 102. For example, the other device may include a mobile device (e.g., a smart phone) or a wearable device (e.g., a smartwatch or headset) that includes the microphone 110, the image sensor 112, the input device 114, the speaker 117, or a combination thereof. Although the device 102 is described as being coupled to or including the microphone 110, the image sensor 112, the input device 114, the display device 116, the speaker 117, and the modem 118, in other embodiments such elements are optional and, in such embodiments, the device 102 may not include or be coupled to the microphone 110, the image sensor 112, the input device 114, the display device 116, the speaker 117, the modem 118, or a combination thereof.

During operation of the system 100, the processor 108 may perform one or more operations to support an on-device training process for the personalized TTS model 142. Performance of the operations by the processor 108 may support a speech application that utilizes the personalized TTS model 142. Prior to performing the on-device training described below (e.g., prior to training the personalized TTS model 142 based on the training samples 158), the personalized TTS model 142 is a trained TTS model that is configured to output synthetic speech based on input text. In some embodiments, the personalized TTS model 142 begins as a TTS model that is not trained for a particular user and that is instead trained to mimic pronunciation, voice, and/or vocal characteristics of one or more test users that do not include the user of the device 102. For example, the personalized TTS model 142 may begin as a zero-shot TTS model that is not trained for the user of the device 102. In some other embodiments, the personalized TTS model 142 is trained for a particular user, which may include the user of the device 102, but more training and personalization is desired. For example, the personalized TTS model 142 may begin as a zero-shot or few-shot TTS model that is trained to mimic the user of the device 102 or another user, and the operations described herein may be performed to improve the quality of the personalized TTS conversion of the personalized TTS model 142 using on-device training.

In some embodiments, prior to performing the on-device training process, the user may register one or more vocabularies or lexicons for use in training the personalized TTS model 142. For example, the user may register a vocabulary as the lexicon reference 146 that is stored in the memory 106. This vocabulary may include technical jargon, career-specific terms, regional dialect-related terms, terms in one or more different languages, or other words or phrases which are expected to be used frequently by the user but not by a general population. To cover a wide range of speaking styles of users, the on-device training includes the collection of diverse speech samples from the user (e.g., a target user). Additionally, by letting users register a vocabulary set that is frequently used (e.g., technical jargons), the on-device training can selectively collect speech samples that include key words from the vocabulary, resulting in enhanced TTS pronunciation that is useful to the user.

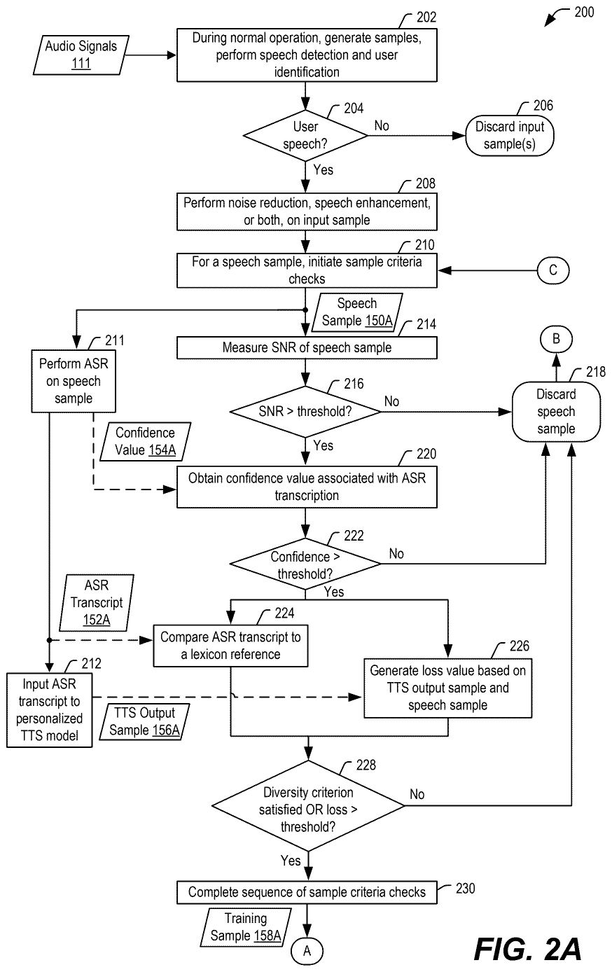

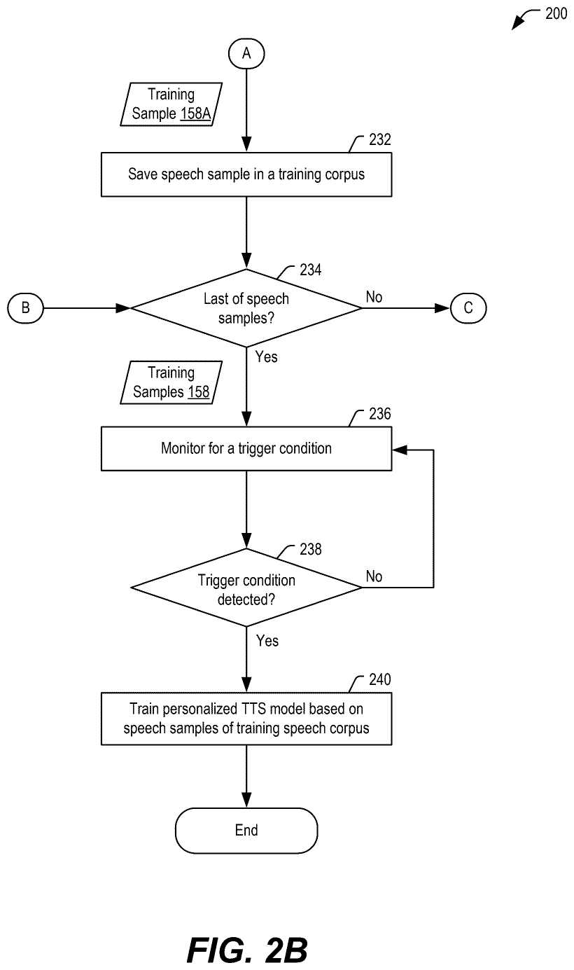

The operations of the on-device training process are described with reference to FIGS. 2A and 2B, which depict an example of a method 200 performed by the system 100 of FIG. 1. For example, operations of the method 200 may be performed by the model trainer 120, the training data generator 122, the noise reduction/filter 124, the ASR engine 126, the criteria checker 128, the scheduler 138, the personalized TTS model 142, the processor 108, the device 102, or the system 100, as non-limiting examples.

The method 200 begins in FIG. 2A and includes, during normal operation, generating input samples and performing speech detection and user identification, at 202. For example, the processor 108 may obtain the audio signals 111 generated by the microphone 110 during normal operation of the device 102. To illustrate, the audio signals 111 may be captured during phone call(s), during interaction with the speech application, during interaction with videoconferencing or other communication applications, periodically or according to a fixed schedule, or a combination thereof. In some embodiments, the user may control one or more settings to indicate particular times when the audio signals 111 are to be obtained, or when audio capture is to be disabled. The audio signals 111 include user speech of the user of the device 102. The noise reduction/filter 124 may generate input audio samples based on the audio signals 111, and the noise reduction/filter 124 may process the input audio samples to improve the quality of the input audio samples, to discard audio samples that are not useful for training the personalized TTS model 142, or both. It may be beneficial to use high-quality text and speech data samples when training the personalized TTS model 142 to fully leverage the performance of the personalized TTS model 142 (or any other pre-trained TTS models) and to avoid performance degradation of the personalized TTS model 142. For this reason, speech samples that include only voice of the user, without noise components, and the corresponding text transcriptions, provide the highest performance for training the personalized TTS model 142. Accordingly, the noise reduction/filter 124 samples the audio signals 111 to generate input audio samples for additional enhancement in order to obtain high-quality speech samples.

The method 200 includes, at 204, determining whether the input audio samples include speech of the user of the device 102. For example, the noise reduction/filter 124 may perform a filtering process on the input audio samples that includes identifying a subset of input samples that include any speech and performing user identification on the subset of input audio samples to identify the user speech in some audio samples and non-user speech in other audio samples. If input audio sample(s) do not include speech of the user of the device 102, the method 200 includes, at 206, discarding the input audio sample(s). For example, the filtering process performed by the noise reduction/filter 124 also includes filtering the subset of audio samples to remove one or more samples that include the non-user speech. In this example, the noise reduction/filter 124 isolates the audio samples that include speech from a single person: the user of the device 102. In some other examples, the noise reduction/filter 124 may filter the subset of audio samples to remove samples that include the non-user speech and do not include the user speech, thereby isolating audio samples that include speech of the user along with speech of other people.

Returning to 204, if input audio sample(s) include the user speech, the method 200 continues to 208, and noise reduction, speech enhancement, or both, are performed on the input audio samples to generate speech samples for processing. For example, the noise reduction/filter 124 may perform one or more noise reduction operations on the input audio samples (e.g., that include user speech) to reduce or eliminate noise components included in the samples. Additionally, or alternatively, the noise reduction/filter 124 may perform one or more other speech enhancement operations on the input audio samples. For example, the noise reduction/filter 124 may perform speech enhancement operations that include adjusting one or more audio levels associated with the input audio samples, performing one or more other filtering operations, performing one or more pre-processing operations on the input audio samples, or a combination thereof. After completion of the filtering and processing performed by the noise reduction/filter 124, the remaining input audio samples may be passed on as the speech samples 150.

The method 200 includes, at 210, initiating sample criteria checks for each of the speech samples. For example, for each of the speech samples 150, the criteria checker 128 may initiate performance of a sequence of criteria checks on each of the speech samples 150 to generate the training samples 158 for use in training the personalized TTS model 142. The sequence of sample criteria checks performed by the criteria checker 128 is related to fitness of successful samples for use in training the personalized TTS model 142. In this manner, each of the speech samples 150 may be processed as a sample under test by the criteria checker 128, and those that are fit for training the personalized TTS model 142 are output as the training samples 158. Although each sample under test is described as being processed individually, multiple of the speech samples 150 may be processed as groups or in parallel. For ease of description, operations are described with reference to a speech sample 150A (e.g., a sample under test). After initiating the sequence of sample checks, the method 200 proceeds to 211 and to 214.

The method 200 includes, at 211, performing one or more ASR operations on the sample under test to generate an ASR transcript. For example, the ASR engine 126 may perform one or more ASR operations on the sample under test 150A to generate the ASR transcript 152A and the confidence value 154A. The ASR transcript 152A includes text data that represents the user speech (e.g., the words, phrases, sentences, etc.) included in the sample under test 150A and the confidence value 154A indicates a confidence determined by the ASR engine 126 that the text included in the ASR transcript 152A matches the words, phrases, etc., in the sample under test 150A. As an illustrative example, if for a sample under test 150A that includes the user speech “this is a house”, an ASR transcript 152A that includes the text “this is my house” may have a higher confidence value 154A than an ASR transcript 152A that includes the text “this is a mouse”. In some embodiments, the ASR engine 126 can provide the ASR transcript 152A to the user of the device 102 and the user can generate a user confidence score that replaces, or is aggregated with, the confidence value 154A. In other embodiments, the user is not provided with the ASR transcript 152A to minimize the time and effort of the user in performing the sequence of criteria checks. The ASR transcript 152A and the confidence value 154A may be used during one or more other operations of the method 200 described below.

In addition to generating the ASR transcript 152A and the confidence value 154A at 211, the method 200 includes, at 212, inputting the ASR transcript 152A to the personalized TTS model 142. For example, the ASR engine 126 may provide the ASR transcript 152A to the personalized TTS model 142 to generate the TTS output sample 156A associated with the sample under test 150A. The TTS output sample 156A is synthetic speech that is generated by the personalized TTS model 142 based on the ASR transcript 152A. For example, if the ASR transcript 152A includes the text “this is a house”, the TTS output sample 156A includes synthetic speech samples that should include the words “this is a house”. Prior to completion of the on-device training, the TTS output sample 156A may mimic the voice, vocal characteristics, and speech patterns of one or more test speakers (e.g., people who are not the user of the device 102) or that somewhat mimic the voice, vocal characteristics, and speech patterns of the user, but which for which the similarities are to be improved by performance of the on-device training. The TTS output sample 156A may be used during one or more other operations of the method 200 described below. It is noted that the operations performed at 211 and 212 may be performed in parallel with, or in series with, any of the operations described below with reference to 214-222, such that the ASR transcript 152A and the TTS output sample 156A are available at 224 and 228, respectively.

Returning to 210 and continuing to 214, the method 200 includes measuring an SNR value associated with the sample under test. For example, the criteria checker 128 may, as part of the SNR check 130, measure an SNR value associated with the sample under test 150A. In some embodiments, the SNR measurement is determined using a pseudo-SNR measuring algorithm. Alternatively, the SNR measurement may be measured using other techniques. The method 200 includes comparing the SNR value to an SNR threshold, at 216. For example, the SNR check 130 may include the criteria checker 128 comparing the SNR value associated with the sample under test 150A to an SNR threshold (e.g., one of the thresholds 144). If the SNR measurement fails to exceed the SNR threshold, the method 200 proceeds to 218, and the sample under test 150A is discarded (e.g., the sample under test 150A is not included in the training samples 158). After the sample under test 150A is discarded, the method 200 proceeds to 234, described further below.

Returning to 216, if the SNR measurement exceeds the SNR threshold (e.g., the sample under test 150A includes a good quality speech signal), the method 200 continues to 220. At 220, the method 200 includes obtaining a confidence value associated with an ASR transcription. For example, the criteria checker 128 may obtain the confidence value 154A output by the ASR engine 126. At 222, the method 200 includes comparing the confidence value to a transcription confidence threshold. For example, the criteria checker 128 may perform the confidence check 132 whether the confidence value 154A associated with the sample under test 150A exceeds a transcription confidence threshold (e.g., one of the thresholds 144). If the confidence value 154A fails to exceed the transcription confidence threshold, the method 200 proceeds to 218, and the sample under test 150A is discarded before the method 200 proceeds to 234, described further below. Alternatively, if the confidence value 154A exceeds the transcription confidence threshold (e.g., indicating there is a reasonable confidence that the ASR transcript 152A is correct) at 222, the method 200 proceeds to 224 and 226 (e.g., either sequentially or in parallel).

The method 200 includes, at 224, comparing the ASR transcript 152A to a lexicon reference to generate a diversity metric. For example, the criteria checker 128 may compare the ASR transcript 152A to the lexicon reference 146 to generate a diversity metric that represents a diversity between the words, phrases, sentences, etc., included in the ASR transcript 152A and the words, phrases, sentences, etc., included in the lexicon reference 146. The diversity metric may be an inverse similarity score or another value derived from a similarity score that is generated by the criteria checker 128 based on the comparison. At 226, the method 200 includes generating a loss value based on a comparison of the personalized TTS output sample 156A to the sample under test 150A. For example, the criteria checker 128 may compare the sample under test 150A to the TTS output sample 156A generated by the personalized TTS model 142 to calculate one or more values based on the comparison. A loss value may be derived from the one or more values (or computed directly based on the comparison). In some examples, the loss value can be a cosine loss value, a Euclidean distance value, or a value derived from various other loss functions. In some embodiments, different loss functions can focus on different aspects synthetic speech generated by the personalized TTS model 142, such as pronunciation, correctness of speech, or the like.

At 228, the method 200 includes determining whether the ASR transcript 152A satisfies a lexicon diversity criterion or the loss value exceeds a loss threshold. For example, the criteria checker 128 may perform the loss check 134 and the lexicon check 136 to determine whether either are passed by the sample under test 150A. The loss check 134 may include the criteria checker 128 comparing the loss value associated with the sample under test 150A to a loss threshold (e.g., one of the thresholds 144) to determine whether the loss value exceeds (or is equal to) the loss threshold. It is noted that samples associated with high loss values are considered to satisfy or pass the loss check 134 because a low loss value, in such instances, represents a speech sample that can already be adequately synthesized by the personalized TTS model 142 (e.g., due to previous training), whereas a high loss value can represent a speech sample that the personalized TTS model 142 lacks sufficient training to adequately synthesize. In this manner, hard samples may be collected by measuring loss values for the respective samples using the untrained, or previously trained, version of the personalized TTS model 142, which enables on-device training without sending the user's private identity or speech to a server.

Additionally, the criteria checker 128 may perform the lexicon check 136 to determine whether the ASR transcript 152A associated with the sample under test 150A satisfies a lexicon diversity criterion represented by one of the thresholds 144. To illustrate, the criteria checker 128 may compare the diversity metric generated based on the comparison of the ASR transcript 152A and the lexicon reference 146 to a diversity threshold included in the thresholds 144 to determine whether the ASR transcript 152A satisfies the diversity criterion. As explained above, in some embodiments, the lexicon reference 146 includes a vocabulary associated with initial training of the personalized TTS model 142, such as one that is stored at the memory 106 or received from another device. In such embodiments, the ASR transcript 152A satisfies the lexicon diversity criterion if the diversity metric exceeds (or is equal to) the diversity threshold, and the ASR transcript 152A fails the lexicon diversity criterion if the diversity metric fails to exceed (or is less than) the diversity threshold. In such an example, the sample under test 150A is sufficiently different than other words, phrases, or sentences that have already been used to train the personalized TTS model 142 (e.g., the personalized TTS model 142 can already adequately synthesize the words, phrases, or sentences), and thus the sample under test 150A is expected to be beneficial to the training of the personalized TTS model 142. For example, training the personalized TTS model 142 based on such a sample under test 150A may increase the vocabulary that is adequately synthesized by the personalized TTS model 142. Additionally, or alternatively, the lexicon reference 146 can include at least a portion of one or more ASR transcriptions of one or more samples that have already been tested, such that additional samples that pass the lexicon check 136 are sufficiently different from samples being added to the training samples 158.

In some other embodiments, the lexicon reference 146 may include includes a user-defined vocabulary that may include technical jargon, career-specific terms, regional dialect-related terms, terms in one or more different languages, or other words or phrases which are expected to be used frequently by the user but not by a general population, other vocabularies, or a combination thereof. In such embodiments, the ASR transcript 152A satisfies the lexicon diversity criterion if the diversity metric fails to exceed (or is less than) the diversity threshold (e.g., a similarity score is greater than or equal to a similarity threshold), and the ASR transcript 152A fails the lexicon diversity criterion if the diversity metric exceeds (or is equal to) the diversity threshold. In such examples, the sample under test 150A is sufficiently similar to a target vocabulary that the sample under test 150A is expected to be beneficial to training the personalized TTS model 142 to personalize the personalized TTS model 142 with respect to the target vocabulary, such as by improving the pronunciation or synthesized vocalization of the target vocabulary. It is noted that the operations described with respect to 226 are optional and, in some embodiments, the method 200 includes the operations described with reference to 224 (e.g., determining the loss value) and not the operations described with reference to 226 (e.g., determining the lexicon diversity criterion).

If the ASR transcript 152A fails to satisfy the lexicon diversity criterion and the loss value fails to exceed (or is less than) the loss threshold, the method 200 proceeds to 218, and the sample under test 150A is discarded and then the method 200 proceeds to 234, described further below. Alternatively, if the ASR transcript 152A satisfies the diversity criterion, the loss value exceeds the loss threshold (e.g., the personalized TTS model 142 can already adequately synthesize the sample under test 150A), or both, the method 200 proceeds to 230. It is noted that speech samples can be desirable for training if the sample has a sufficiently high loss value as compared to synthesized speech or if the sample has a sufficiently diverse lexicon (or matches a target lexicon). However, in other embodiments, if the personalized TTS model 142 has undergone significant training, the determination at 228 can be modified to select speech samples having a sufficiently high loss value and that satisfy the diversity criterion. At 230, the method 200 includes completing the sequence of sample criteria checks for the sample under test 150A. For example, if the speech sample 150A reaches 230 without being discarded, the sample under test 150A has successfully completed the sequence of sample criteria checks and is fit for being used as a training sample 158A to train the personalized TTS model 142.

Continuing to FIG. 2B, at 232, the method 200 includes saving the sample under test 150A in a training corpus. For example, the sample under test 150A (e.g., the training sample 158A) may be included in the training samples 158, which may be stored at the memory 106. The method 200 includes, at 234, determining whether the last speech sample has been processed using the sequence of criteria checks. If there are more speech samples to be processed, the method 200 returns to 210, and the sequence of sample criteria checks is initiated for a next sample under test of the speech samples 150. Alternatively, if all of the speech samples 150 have been processed, the method 200 proceeds to 236. Thus, after 234, the training samples 158 are generated (and optionally stored at the memory 106). As such, the training samples 158 include one or more speech samples that are each associated with a corresponding SNR value that exceeds the SNR threshold, a corresponding confidence value that exceeds the transcription confidence threshold, and either: a corresponding loss value that exceeds the loss threshold; or a corresponding ASR transcript that satisfies the lexicon diversity criterion (or both).

At 236, the method 200 includes monitoring for a trigger condition associated with the device. For example, the scheduler 138 may monitor to detect whether the trigger condition 140 has occurred. The trigger condition 140 may include transition of the device 102 to a sleep mode, a target time of day (e.g., a time during which the user of the device 102 is sleeping), receipt of a user input associated with training the personalized TTS model 142, operation of the device 102 in a low power operating mode (e.g., an idle mode, a notifications silenced mode, or the like) for a threshold time period, the device 102 being connected to an external power source, one or more other conditions, or a combination thereof. At 238, the method 200 includes determining whether the trigger condition 140 is detected. If the trigger condition 140 is not detected, the method 200 returns to 236, and the scheduler 138 continues to monitor for the trigger condition 140. Alternatively, if the trigger condition 140 is detected, the method 200 continues to 240. At 240, the method 200 includes training the personalized TTS model 142 based on speech samples of the training corpus. For example, the scheduler 138 may initiate training of the personalized TTS model 142 based on (e.g., using) the training samples 158. As such, the on-device training of the personalized TTS model 142 can typically occur during a fixed time period (e.g., overnight while the device 102 is being charged). In some embodiments, an estimated training time may be determined based on the training samples 158, and if the estimated training time does not exceed the fixed time period, the training is initiated (or the training is initiated for only a portion of the training samples 158). Additionally, or alternatively, the scheduler 138 may condition the training on one or more user settings.

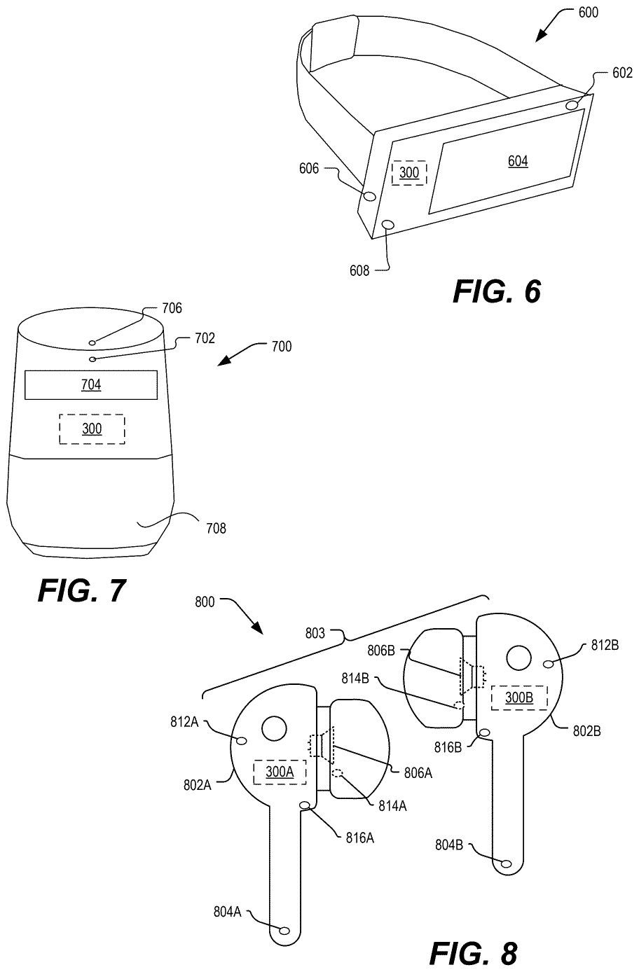

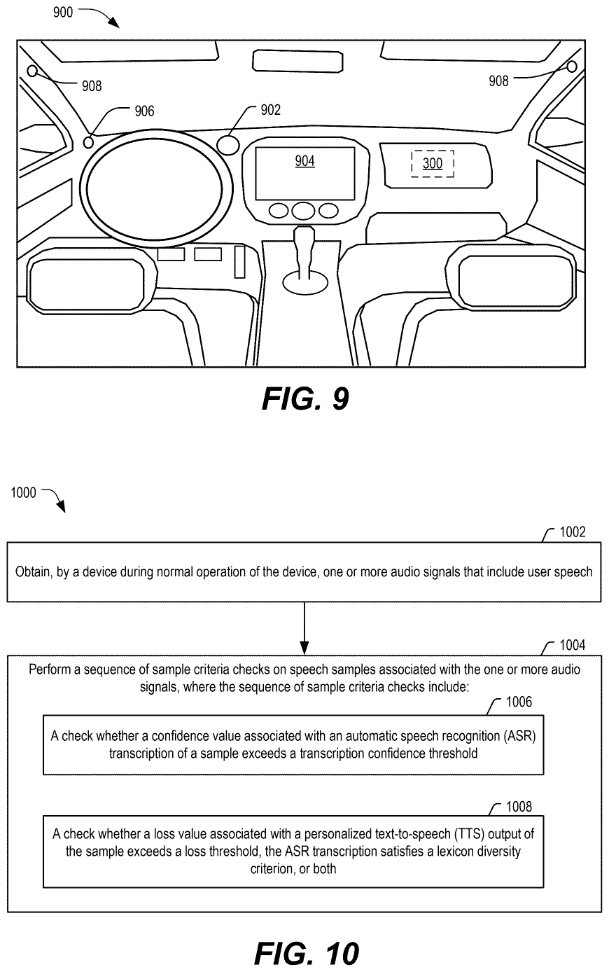

Returning to FIG. 1, in some examples, the device 102 corresponds to or is included in one of various types of devices, such that the processor 108 can be integrated in multiple types of devices. In an illustrative example, the processor 108 is integrated in a wearable device, such as a headset as depicted in FIG. 5, a wearable electronic device as depicted in FIG. 6, earbuds as described with reference to FIG. 8, or another wearable device. In another illustrative example, the processor 108 is integrated in a mobile device (a mobile phone or a tablet) as depicted in FIG. 4, a voice-controlled speaker system as depicted in FIG. 7, a vehicle as depicted in FIG. 9, a computer or a server, or another system or device.

In a particular example, the device 102 includes a memory (e.g., the memory 106) configured to store a set of speech samples (e.g., the training samples 158). The device 102 also includes one or more processors (e.g., the processor 108) coupled to the memory. The one or more processors are configured to obtain, during normal operation of the device, one or more audio signals (e.g., the audio signals 111) that include user speech and perform a sequence of sample criteria checks on the speech samples (e.g., the speech samples 150) associated with the one or more audio signals. The sequence of sample criteria checks includes a check (e.g., the confidence check 132) whether a confidence value associated with an ASR transcription (e.g., the ASR transcript(s) 152) of a sample exceeds a transcription confidence threshold (e.g., of the thresholds 144). The sequence of sample criteria checks also includes a check (e.g., the loss check 134) whether a loss value associated with a personalized TTS output (e.g., the TTS output samples 156) of the sample exceeds a loss threshold (e.g., of the thresholds 144), whether the ASR transcription satisfies a lexicon diversity criterion (e.g., based on a comparison to the lexicon reference 146), or both.

One technical advantage of implementing the device 102 as described above is improved performance of the personalized TTS model 142 based on continuous training using the training samples 158 that include high-quality speech samples (e.g., after undergoing one or more criteria checks performed by the training data generator 122). Therefore, the personalized TTS model 142 can generate synthesized speech having similar voice and vocal characteristics of the user of the device 102 in a more convenient and less obtrusive manner than other personalized TTS model training, such as other personalized TTS model training procedures that require a user to record themselves reading a large set of training samples or to manually create or verify transcripts. Instead, the personalized TTS model 142, which may begin (prior to training using the training samples 158) as a non-personalized TTS model, a one-shot personalized TTS model, or a few-shot personalized TTS model, can be trained to improve performance and personalization without extensive input from the user. Additionally, because the audio signals 111, and thus the speech samples 150, are collected during normal operation of the device 102, the speech samples 150 are more likely to include frequently used words and phrases that are specific to the user, such as technical jargons, particular languages, etc., than if the user recorded themselves reading a more broadly designed training set.

Additionally, because the training samples 158 are selected based on criteria checks performed by the criteria checker 128, the training samples 158 have good quality and include speech samples with a high likelihood of providing benefit to the training of the personalized TTS model 142. For example, each of the training samples 158 may satisfy the loss check 134, the lexicon check 136, or both, that result in selection of speech samples that are sufficiently different than samples generated by the personalized TTS model 142 (e.g., based on a loss value) or that represent either diverse words or phrases or target words or phrases, and thus are likely to provide useful information for training the personalized TTS model 142. Another technical benefit is that the device 102 performs the training of the personalized TTS model 142 on-device, thereby avoiding data privacy or security issues and increased network overhead associated with sending the training samples 158 to another device for off-device training of the personalized TTS model 142.

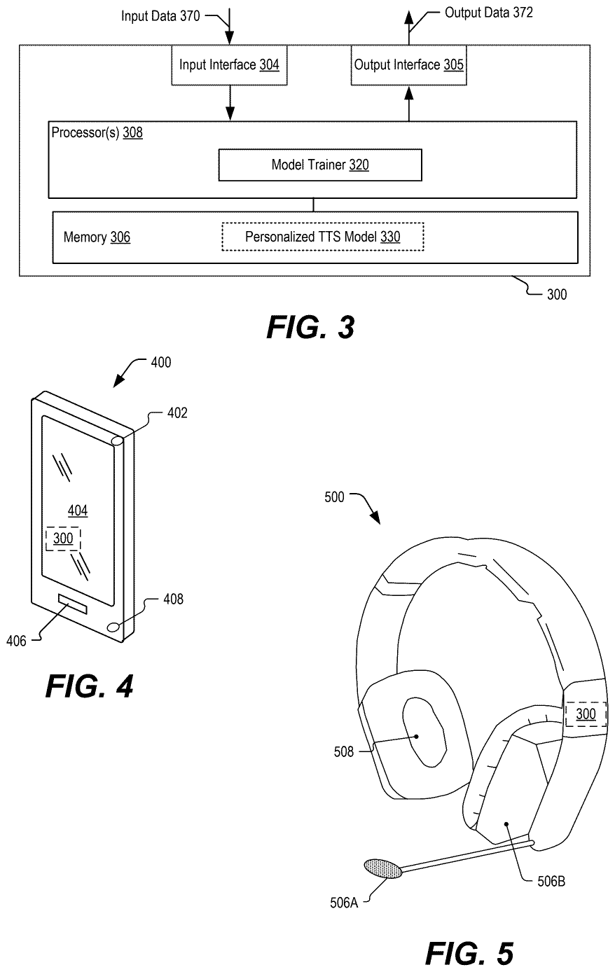

FIG. 3 depicts a diagram of an example of an integrated circuit 300 operable to support on-device speech sample generation for a personalized TTS model, in accordance with some examples of the present disclosure. The integrated circuit 300 includes one or more processors 308 (herein after referred to as the “processor 308”) and a memory 306. The processor 308 and the memory 306 may include or correspond to the processor 108 and the memory 106, respectively. The processor 308 includes a model trainer 320, which includes or corresponds to the model trainer 120 of FIG. 1 and may include the training data generator 122, the scheduler 138, or both. In some embodiments, the memory 306 includes (e.g., stores) a personalized TTS model 330. The personalized TTS model 330 may include or correspond to the personalized TTS model 142 of FIG. 1. The personalized TTS model 330 is optional, such that in some embodiments, the memory 306 stores the personalized TTS model 330 and in some other embodiments, the personalized TTS model 330 is stored at another device, such as a device to which the integrated circuit 300 is communicatively coupled.

The integrated circuit 300 also includes an input interface 304, such as one or more bus interfaces, to enable the integrated circuit 300 to receive signals representing input data 370 for processing. For example, the input data 370 can correspond to or include the audio signals 111, the input data 115, the TTS output samples 156, or a combination thereof.

The integrated circuit 300 also includes an output interface 305, such as a bus interface, to enable the integrated circuit 300 to output signals representing output data 372. For example, the output data 372 can correspond to or include the ASR transcript(s) 152, the training samples 158, synthetic speech generated by the personalized TTS model 330 after training, or a combination thereof.

The integrated circuit 300 including the model trainer 320 and, optionally, the personalized TTS model 330 enables implementation of on-device speech sample generation for personalizing a TTS model as a component in a system or a device. For example, the system or the device may include a mobile device (e.g., a mobile phone or tablet) as depicted in FIG. 4, a headset as depicted in FIG. 5, a wearable electronic device as depicted in FIG. 6, earbuds, as described with reference to FIG. 8, or a vehicle as depicted in FIG. 9.

In some embodiments, the system or the device that includes the integrated circuit 300 also includes or is coupled to an image sensor (e.g., a camera), an input device (e.g., a microphone, a keyboard or touch screen, etc.), a microphone, a display device, a speaker, a modem, or a combination thereof. For example, the image sensor, the input device, the microphone, the display device, the speaker, and the modem may include or correspond to the image sensor 112, the input device 114, the microphone 110, the display device 116, the speaker 117, and the modem 118, respectively.

In some embodiments, the system or the device that includes the integrated circuit 300 is operable to obtain speech samples from audio signals captured by the microphone(s) of the system or the device during normal operation and perform a sequence of criteria checks on the speech samples to generate a training set of samples for training the personalized TTS model 330. Training the personalized TTS model 330 based on the training set of samples enables the system or the device to support on-device training to personalize a TTS model, such as for use with a language application.

FIG. 4 depicts a diagram of a mobile device 400 operable to support on-device speech sample generation for a personalized TTS model, in accordance with some examples of the present disclosure. The mobile device 400 may include or correspond to a phone or a tablet, as illustrative, non-limiting examples. The mobile device 400 includes a camera 402 (e.g., an image sensor), a display 404 (e.g., a display screen), a microphone 406, a speaker 408, and the integrated circuit 300. Components of the integrated circuit 300, including the model trainer 320, are integrated in the mobile device 400 and are illustrated using dashed lines to indicate internal components that are not generally visible to a user of the mobile device 400.

In a particular example, the model trainer 320 is operable to obtain speech samples from audio signals captured by the microphone(s) 406 during normal operation of the mobile device 400, such as during a phone call, video conference, or gaming session at the mobile device 400, and perform a sequence of criteria checks on the speech samples to generate a training set of samples for training a personalized TTS model (e.g., the personalized TTS model 330). Training the personalized TTS model based on the training set of samples enables the mobile device 400 to support on-device training to personalize a TTS model, such as for use with a language application.

FIG. 5 depicts a diagram of a headset device 500 operable to support on-device speech sample generation for a personalized TTS model, in accordance with some examples of the present disclosure. The headset device 500 includes one or more microphones 506 and one or more speakers 508. In some examples, the microphones 506 include an input microphone 506A and an inner ear, or bone conduction, microphone 506B. Components of the integrated circuit 300, including the model trainer 320, are integrated in the headset device 500.

In a particular example, the model trainer 320 is operable to obtain speech samples from audio signals captured by the microphone(s) 506 during normal operation of the headset device 500 and perform a sequence of criteria checks on the speech samples to generate a training set of samples for training a personalized TTS model (e.g., the personalized TTS model 330). In some embodiments, the headset device 500 may send the audio signals or speech samples to a user device, such as a smart phone, that is communicatively coupled to the headset device 500, and the sequence of criteria checks and the training may be performed by the user device. Training the personalized TTS model based on the training set of samples enables the headset device 500 (and in some embodiments, the user device) to support on-device training to personalize a TTS model, such as for use with a language application.

FIG. 6 depicts a diagram of a wearable electronic device 600 operable to support on-device speech sample generation for a personalized TTS model, in accordance with some examples of the present disclosure. The wearable electronic device 600 may include or correspond to a “smart watch,” as an illustrative, non-limiting example. The wearable electronic device 600 includes a camera 602 (e.g., an image sensor), a display 604 (e.g., a display screen), a microphone 606, a speaker 608, and the integrated circuit 300. Components of the integrated circuit 300, including model trainer 320, is integrated in the wearable electronic device 600 and are illustrated using dashed lines to indicate internal components that are not generally visible to a user of the wearable electronic device 600.

In a particular example, the model trainer 320 is operable to obtain speech samples from audio signals captured by the microphone 606 during normal operation of the wearable electronic device 600 and perform a sequence of criteria checks on the speech samples to generate a training set of samples for training a personalized TTS model (e.g., the personalized TTS model 330). Training the personalized TTS model based on the training set of samples enables the wearable electronic device 600 to support on-device training to personalize a TTS model, such as for use with a language application.

FIG. 7 is a diagram of a voice-controlled speaker system 700 operable to support on-device speech sample generation for a personalized TTS model, in accordance with some examples of the present disclosure. The voice-controlled speaker system 700 may include or correspond to a wireless speaker and voice activated device, as an illustrative, non-limiting example. The voice-controlled speaker system 700 can have wireless network connectivity and is configured to execute an assistant operation. The voice-controlled speaker system 700 includes a camera 702 (e.g., an image sensor), a display 704 (e.g., a display screen), a microphone 706, a speaker 708, and the integrated circuit 300. Components of the integrated circuit 300, including the model trainer 320, are integrated in the voice-controlled speaker system 700 and are illustrated using dashed lines to indicate internal components that are not generally visible to a user of the voice-controlled speaker system 700.

In a particular example, the model trainer 320 is operable to obtain speech samples from audio signals captured by the microphone 706 during normal operation of the voice-controlled speaker system 700, such as during one or more automated voice assistant sessions, and perform a sequence of criteria checks on the speech samples to generate a training set of samples for training a personalized TTS model (e.g., the personalized TTS model 330). Training the personalized TTS model based on the training set of samples enables the voice-controlled speaker system 700 to support on-device training to personalize a TTS model, such as for use with a language application.

FIG. 8 depicts an example of earbuds 800 operable to support on-device speech sample generation for a personalized TTS model, in accordance with some examples of the present disclosure. The earbuds 800 include a first earbud 802A and a second earbud 802B, which can also be referred to as an earbud pair 803. Although earbuds are described, it should be understood that the present technology can be applied to other in-ear or over-ear audio devices. Although two earbuds (e.g., the first earbud 802A and the second earbud 802B) are shown in FIG. 8, in other examples, the aspects described herein may be integrated into a single earbud.

The first earbud 802A includes a first microphone 804A, such as a high signal-to-noise microphone positioned to capture the voice of a wearer of the first earbud 802A, an array of one or more other microphones configured to detect ambient sounds and spatially distributed to support beamforming, illustrated as microphone 812A, an “inner” microphone 814A proximate to the wearer's ear canal (e.g., to assist with active noise cancelling), and a self-speech microphone 816A, such as a bone conduction microphone configured to convert sound vibrations of the wearer's ear bone or skull into an audio signal. The first earbud 802A also includes one or more speakers 806A. The second earbud 802B can be configured in a substantially similar manner as the first earbud 802A. For example, the second earbud 802B may include a second microphone 804B, an array of one or more other microphones (illustrated as microphone 812B), an “inner” microphone 814B, a self-speech microphone 816B, and one or more speakers 806B. In some embodiments, the first earbud 802A is also configured to receive one or more audio signals generated by one or more microphones of the second earbud 802B, such as via wireless transmission between the first earbud 802A and the second earbud 802B, or via wired transmission in implementations in which the first earbud 802A and the second earbud 802B are coupled via a transmission line.

In some embodiments, the earbuds 800 are configured to automatically switch between various operating modes, such as a passthrough mode in which ambient sound is played via the speakers 806A, 806B, a playback mode in which non-ambient sound (e.g., streaming audio corresponding to a phone conversation, media playback, a video game, etc.) is played back through the speakers 806A, 806B, and an audio zoom mode or beamforming mode in which one or more ambient sounds are emphasized and/or other ambient sounds are suppressed for playback at the speakers 806A, 806B. In other embodiments, the earbuds 800 may support fewer modes or may support one or more other modes in place of, or in addition to, the described modes.

In an illustrative example, the earbuds 800 can automatically transition from the playback mode to the passthrough mode in response to detecting the wearer's voice and may automatically transition back to the playback mode after the wearer has ceased speaking. In some examples, the earbuds 800 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music.

In FIG. 8, the integrated circuit 300 is integrated in the earbuds 800 and is illustrated using dashed lines to indicate internal components that are not generally visible to a user of the earbuds 800. For example, a first integrated circuit 300A may be integrated in the first earbud 802A, and a second integrated circuit 300B may be integrated in the second earbud 802B. In a particular example, the integrated circuits 300A, 300B (e.g., the model trainer 320) are operable to obtain speech samples from audio signals captured by the microphone(s) 804, 812, 814, and 816 during normal operation of the earbuds 800 and perform a sequence of criteria checks on the speech samples to generate a training set of samples for training a personalized TTS model (e.g., the personalized TTS model 330). In some embodiments, the earbuds 800 may send the audio signals or speech samples to a user device, such as a smart phone, that is communicatively coupled to the first earbud 802A, the second earbud 802B, or both, and the sequence of criteria checks and the training may be performed by the user device. Training the personalized TTS model based on the training set of samples enables the earbuds 800 (and in some embodiments, the user device) to support on-device training to personalize a TTS model, such as for use with a language application.

FIG. 9 is a diagram of a second example of a vehicle 900 operable to support on-device speech sample generation for a personalized TTS model, in accordance with some examples of the present disclosure. The vehicle 900 may include or correspond to, e.g., a car or an aircraft, and may be configured for manual, semi-autonomous, or fully autonomous operation, in various embodiments. The vehicle 900 includes a camera 902 (e.g., an image sensor), a display 904 (e.g., a display screen), a microphone 906, one or more speakers 908, and the integrated circuit 300. Components of the integrated circuit 300, including the model trainer 320, are integrated in the vehicle 900 and are illustrated using dashed lines to indicate internal components that are not generally visible to a user of the vehicle 900.

In a particular example, the model trainer 320 is operable to obtain speech samples from audio signals captured by the microphone 906 during normal operation of the vehicle 900, such as a user's speech commands for an entertainment or navigation system of the vehicle 900, and perform a sequence of criteria checks on the speech samples to generate a training set of samples for training a personalized TTS model (e.g., the personalized TTS model 330). Training the personalized TTS model based on the training set of samples enables the vehicle 900 to support on-device training to personalize a TTS model, such as for use with a language application.

The embodiments of the systems or devices as described with reference to FIGS. 4-9 are described, respectively, as including components such as a display, a microphone, a speaker, a camera, or a combination thereof. As described with reference to FIGS. 4-9, the display, the microphone, the speaker, the camera may include or correspond to the display device 116, the microphone 110, the speaker 117, and the image sensor 112, respectively. It is noted that in other embodiments of the systems or devices of FIGS. 4-9, one or more of the systems or devices of FIGS. 4-9 may not include the display, the microphone, the speaker, the camera, or a combination thereof. Additionally, or alternatively, one or more of the systems or devices of FIGS. 4-9 may include one or more additional components. For example, the additional component may include a modem, such as the modem 118.

FIG. 10 is a diagram of an example of a method 1000 of on-device speech sample generation for a personalized TTS model, in accordance with some aspects of the present disclosure. In a particular aspect, one or more operations of the method 1000 are performed by the model trainer 120, the training data generator 122, the scheduler 138, the processor 108, the device 102, the system 100, the integrated circuit 300, the processor 308, the model trainer 320, the mobile device 400, the headset device 500, the wearable electronic device 600, the voice-controlled speaker system 700, the earbuds 800, the vehicle 900, or a combination thereof.

In some embodiments, the method 1000 includes, at block 1002, obtaining, during normal operation of a device, one or more audio signals that include user speech. For example, the one or more audio signals may include or correspond to the audio signals 111 of FIG. 1 that are obtained during normal operation of the device 102.

The method 1000 also includes, at block 1004, performing a sequence of sample criteria checks on speech samples associated with the one or more audio signals. For example, the criteria checker 128 of FIG. 1 may perform the checks 130-136 on the speech samples 150, such as to generate the training samples 158 for use to train or adapt the personalized TTS model 142. In some embodiments, the personalized TTS output is generated by a personalized TTS model at the device that is configured to mimic pronunciation of one or more test users. For example, the personalized TTS model 142 may be trained to mimic pronunciation, voice, vocal characteristics or traits, or a combination thereof, of one or more test users prior to performing training or adaptation based on the training samples 158. Alternatively, the personalized TTS model 142 may be trained based on at least some speech samples of the user of the device 102 prior to performing training or adaptation based on the training samples 158.

The sequence of sample criteria checks includes, at block 1006, a check whether a confidence value associated with an ASR transcription of a sample exceeds a transcription confidence threshold. For example, the confidence check 132 may include the criteria checker 128 determining whether the confidence value(s) 154 exceeds a transcription confidence threshold of the thresholds 144.

The sequence of sample criteria checks also includes, at block 1008, a check whether a loss value associated with a personalized TTS output of the sample exceeds a loss threshold, the ASR transcription satisfies a lexicon diversity criterion, or both. For example, the criteria checker 128 may include a speech sample in the training samples 158 if the loss check 134, the lexicon check 136, or both, are passed. The loss check 134 may include the criteria checker 128 determining whether a loss value associated with a comparison between the ASR transcript(s) 152 and the TTS output samples 156 exceeds a loss threshold of the thresholds 144. The lexicon check 136 may include the criteria checker 128 determining whether a diversity metric associated with a comparison of the ASR transcript(s) 152 and the lexicon reference 146 satisfies a diversity criterion of the thresholds 144.

In some embodiments, the method 1000 includes, prior to performing the sequence of sample criteria checks, performing one or more noise reduction operations on the speech samples. For example, the noise reduction/filter 124 may perform one or more noise reduction operations on the audio signals derived from the audio signals 111. The method 1000 may also include filtering the speech samples to remove one or more samples that include the non-user speech and do not include the user speech. For example, the noise reduction/filter 124 may filter out (e.g., discard) one or more of the audio samples that do not include speech of the user of the device 102 to generate the speech samples 150. In some such embodiments, the noise reduction/filter 124 performs both the noise reduction and the filtering based on user identification.

The method 1000 provides one or more technical benefits compared to other methods of performing personalized TTS model training or adapting a TTS model. One technical advantage of the method 1000 as described above is improved performance of a personalized TTS model based on continuous training or adaptation using speech samples that have undergone one or more criteria checks, and thus are high-quality speech samples that have a high likelihood of providing useful information for adapting the personalized TTS model to more closely resemble the user's voice and speech patterns. Additionally, the speech sample filtering of the method 1000 is more convenient and less obtrusive manner than other personalized TTS model training or adapting, such as those that require a user to record themselves reading a large set of speech samples or to manually create or verify transcripts. Instead, the method 1000 captures speech samples during normal operation of a device, which may have the added benefit of being more likely to capture frequently used words and phrases (e.g., technical jargons) that are specific to the user. Another technical benefit is that the method 1000 performs on-device speech sample obtaining operations, and optionally on-device training or adapting of the personalized TTS model, thereby avoiding data privacy or security issues and increased network overhead associated with sending speech samples to other devices for off-device training of a personalized TTS model.

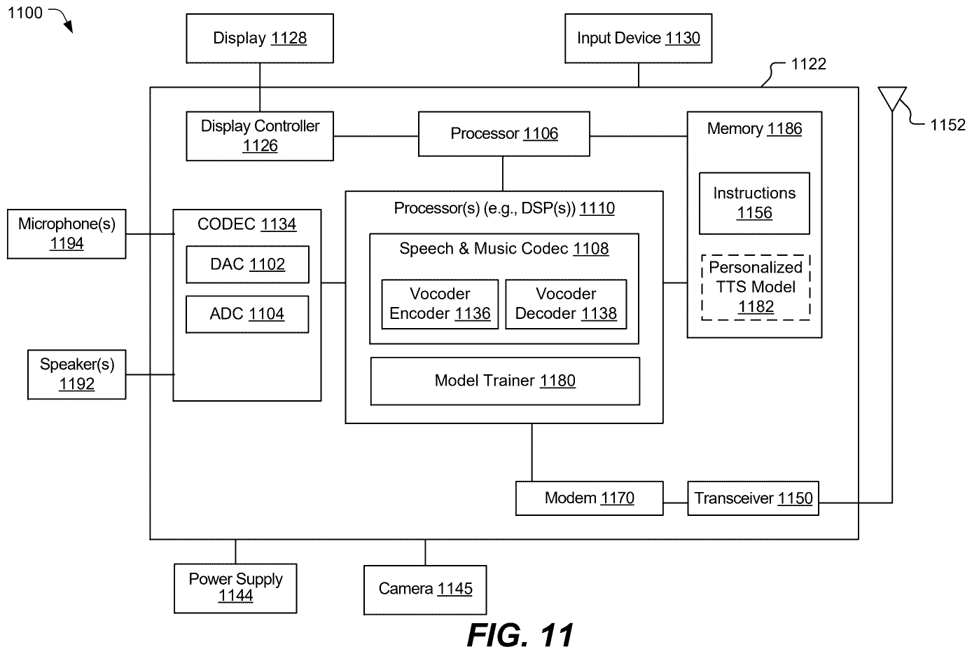

The method 1000 of FIG. 10 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1000 of FIG. 10 may be performed by a processor that executes instructions, such as described with reference to FIG. 11.

It is noted that one or more blocks (or operations) described with reference to FIG. 10 may be combined with one or more blocks (or operations) described with reference to another of the figures. For example, one or more blocks associated with FIG. 10 may be combined with one or more blocks (or operations) associated with FIGS. 1-9. Additionally, or alternatively, one or more operations described above with reference to FIGS. 1-10 may be combined with one or more operations described with reference to FIG. 11.

Referring to FIG. 11, FIG. 11 is a block diagram of an illustrative example of a device 1100 that is operable to support on-device speech sample generation for a personalized TTS model, in accordance with one or more aspects of the present disclosure. In various implementations, the device 1100 may have more or fewer components than illustrated in FIG. 11. In an illustrative implementation, the device 1100 may correspond to the device 102. In an illustrative implementation, the device 1100 may perform one or more operations described with reference to FIGS. 1-10.

In a particular implementation, the device 1100 includes a processor 1106 (e.g., a central processing unit (CPU)). The device 1100 may include one or more additional processors 1110 (e.g., one or more DSPs). In a particular aspect, the processor 108 of FIG. 1 or the processor 308 of FIG. 3 corresponds to the processor 1106, the processors 1110, or a combination thereof. The processors 1110 may include a speech and music coder-decoder (CODEC) 1108 that includes a voice coder (“vocoder”) encoder 1136, a vocoder decoder 1138, or a combination thereof. Additionally, or alternatively, the processors 1110 may include a model trainer 1180. The model trainer 1180 may include or correspond to the model trainer 120 of FIG. 1 or the model trainer 320 of FIG. 3.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1100 may include a memory 1186 and a CODEC 1134. The memory 1186 may include or correspond to the memory 106 or the memory 306. The memory 1186 may include instructions 1156, that are executable by the one or more additional processors 1110 (or the processor 1106) to implement the functionality described with reference to the model trainer 1180, or both. The instructions 1156 may include or correspond to the instructions 109 of FIG. 1. In some embodiments, the memory 1186 also includes a personalized TTS model 1182. The personalized TTS model 1182 may include or correspond to the personalized TTS model 142 of FIG. 1 or the personalized TTS model 330 of FIG. 3. The personalized TTS model 1182 is optional, such that in some embodiments, the memory 1186 stores the personalized TTS model 1182 and in some other embodiments, the personalized TTS model 1182 is stored at another device, such as a device to which the device 1100 is communicatively coupled. The device 1100 may include a modem 1170 coupled, via a transceiver 1150, to an antenna 1152.

The device 1100 may include a display 1128 coupled to a display controller 1126. One or more speakers 1192, one or more microphone(s) 1194, or both may be coupled to the CODEC 1134. The microphone(s) 1194 may include or correspond to the microphone 110 of FIG. 1. The CODEC 1134 may include a digital-to-analog converter (DAC) 1102, an analog-to-digital converter (ADC) 1104, or both. In a particular implementation, the CODEC 1134 may receive analog signals from the microphone(s) 1194, convert the analog signals to digital signals using the analog-to-digital converter 1104, and provide the digital signals to the speech and music codec 1108. The speech and music codec 1108 may process the digital signals, and the digital signals may further be processed by the model trainer 1180. In a particular implementation, the speech and music codec 1108 may provide digital signals to the CODEC 1134. The CODEC 1134 may convert the digital signals to analog signals using the digital-to-analog converter 1102 and may provide the analog signals to the speaker 1192.

In a particular implementation, the device 1100 may be included in a system-in-package or system-on-chip device 1122. In a particular implementation, the memory 1186, the processor 1106, the processors 1110, the display controller 1126, the CODEC 1134, and the modem 1170 are included in the system-in-package or system-on-chip device 1122. In a particular implementation, an input device 1130, a power supply 1144, and a camera 1145 are coupled to the system-in-package or the system-on-chip device 1122. For example, the input device 1130 and the camera 1145 may include or correspond to the input device 114 and the image sensor 112, respectively. In some examples, the input device 1130 may include or be associated with the display device 116 or the display 1128. Moreover, in a particular implementation, as illustrated in FIG. 11, the display 1128, the input device 1130, the speaker(s) 1192, the microphone(s) 1194, the antenna 1152, the power supply 1144, and the camera 1145 are external to the system-in-package or the system-on-chip device 1122. In a particular implementation, each of the display 1128, the input device 1130, the speaker(s) 1192, the microphone(s) 1194, the antenna 1152, the power supply 1144, and the camera 1145 may be coupled to a component of the system-in-package or the system-on-chip device 1122, such as an interface or a controller.

The device 1100 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining, during normal operation of a device, one or more audio signals that include user speech. For example, the means for obtaining can include the microphone 110, the model trainer 120, the training data generator 122, the processor 108, the device 102, the system 100, the input interface 304, the processor 308, the model trainer 320, the integrated circuit 300, the microphone 406, the mobile device 400, the microphones 506, the headset device 500, the microphone 606, the wearable electronic device 600, the microphone 706, the voice-controlled speaker system 700, the microphones 804, the microphones 812, the inner microphones 814, the self-speech microphones 816, the earbuds 800, the microphone 906, the vehicle 900, the processor 1106, the processor(s) 1110, the microphones 1194, the system-in-package or the system-on-chip device 1122, the device 1100, other circuitry configured to obtain audio signals during normal operation of a device, or a combination thereof.

The apparatus also includes means for performing a sequence of sample criteria checks on speech samples associated with the one or more audio signals. For example, the means for performing can include the model trainer 120, the training data generator 122, the criteria checker 128, the processor 108, the device 102, the system 100, the processor 308, the integrated circuit 300, the model trainer 320, the mobile device 400, the headset device 500, the wearable electronic device 600, the voice-controlled speaker system 700, the earbuds 800, the vehicle 900, the processor 1106, the processor(s) 1110, the system-in-package or the system-on-chip device 1122, the device 1100, other circuitry configured to perform a sequence of sample criteria checks on speech samples to generate a training set of samples, or a combination thereof. The sequence of sample criteria checks includes a check whether a confidence value associated with an ASR transcription of a sample exceeds a transcription confidence threshold. The sequence of sample criteria checks also includes a check whether a loss value associated with a personalized TTS output of the sample exceeds a loss threshold, the ASR transcription satisfies a lexicon diversity criterion, or both.

In some implementations, a non-transitory computer-readable medium (e.g., a computer-readable storage device, such as the memory 106, the memory 306, or the memory 1186) includes instructions (e.g., the instructions 109 or the instructions 1156) that, when executed by one or more processors (e.g., the processor 108, the processor 308, the one or more processors 1110, or the processor 1106), cause the one or more processors to obtain, during normal operation of a device (e.g., the device 102, the integrated circuit 300, the mobile device 400, the headset device 500, the wearable electronic device 600, the voice-controlled speaker system 700, the earbuds 800, the vehicle 900, or the device 1100), one or more audio signals (e.g., the audio signals 111) that include user speech. The instructions also cause the one or more processors to perform a sequence of sample criteria checks on speech samples (e.g., the speech samples 150) associated with the one or more audio signals. The sequence of sample criteria checks includes a check (e.g., the confidence check 132) whether a confidence value (e.g., the confidence value(s) 154) associated with an ASR transcription (e.g., the ASR transcript(s) 152) of a sample exceeds a transcription confidence threshold (e.g., one of the thresholds 144). The sequence of sample criteria checks also includes a check (e.g., the loss check 134 and the lexicon check 136) whether a loss value associated with a personalized TTS output (e.g., the TTS output samples 156) of the sample exceeds a loss threshold (e.g., one of the thresholds 144), the ASR transcription satisfies a lexicon diversity criterion (e.g., one of the thresholds 144), or both.

Particular aspects of the disclosure are described below in sets of interrelated Examples:

According to Example 1, a device includes: a memory configured to store a set of speech samples; and one or more processors coupled to the memory. The one or more processors are configured to: obtain, during normal operation of the device, one or more audio signals that include user speech; and perform a sequence of sample criteria checks on the speech samples associated with the one or more audio signals, wherein the sequence of sample criteria checks includes: a check whether a confidence value associated with an automatic speech recognition (ASR) transcription of a sample exceeds a transcription confidence threshold; and a check whether a loss value associated with a personalized text-to-speech (TTS) output of the sample exceeds a loss threshold, the ASR transcription satisfies a lexicon diversity criterion, or both.

Example 2 includes the device of Example 1, wherein the sequence of sample criteria checks is related to fitness of the speech samples for use in adapting a personalized TTS model at the device.

Example 3 includes the device of Example 1 or Example 2, wherein, after performance of the sequence of sample criteria checks, the set of speech samples includes one or more speech samples of the speech samples that are associated with a corresponding confidence value that exceeds the transcription confidence threshold and that are associated with a corresponding loss value that exceeds the loss threshold or a corresponding ASR transcript that satisfies the lexicon diversity criterion.

Example 4 includes the device of any of Examples 1 to 3, wherein the sequence of sample criteria checks further includes a check whether a signal-to-noise ratio (SNR) value associated with the sample under test exceeds an SNR threshold, and wherein, after performance of the sequence of sample criteria checks, each speech sample of the set of speech samples is associated with a corresponding SNR value that exceeds the SNR threshold.

Example 5 includes the device of Example 4, wherein the one or more processors are further configured to: measure the SNR value associated with the sample; and compare the SNR value to the SNR threshold.

Example 6 includes the device of any of Examples 1 to 5, wherein the one or more processors are further configured to adapt a personalized TTS model based on the set of speech samples.

Example 7 includes the device of Example 6, wherein the one or more processors are further configured to adapt the personalized TTS model based on detection of a trigger condition associated with the device.

Example 8 includes the device of Example 7, wherein the trigger condition includes transition of the device to a sleep mode, detection of a target time of day, receipt of a user input associated with adapting the personalized TTS model, operation of the device in a low power operating mode for a threshold time period, detection of the device being connected to an external power source, or a combination thereof.

Example 9 includes the device of any of Examples 1 to 8, wherein the one or more processors are further configured to: perform one or more ASR operations on the sample to generate the ASR transcription and the confidence value, wherein the ASR transcription includes text data that represents the user speech included in the sample under test, and wherein the confidence value indicates a confidence that the text data matches the user speech; and compare the confidence value to the transcription confidence threshold.

Example 10 includes the device of any of Examples 1 to 9, wherein the one or more processors are further configured to: provide the ASR transcription to a personalized TTS model to generate the personalized TTS output of the sample; generate the loss value based on a comparison of the personalized TTS output to the sample; and compare the loss value to the loss threshold.

Example 11 includes the device of any of Examples 1 to 10, wherein the one or more processors are further configured to: compare the ASR transcription to a reference; and determine whether the ASR transcription satisfies the lexicon diversity criterion based on the comparison.

Example 12 includes the device of Example 11, wherein the reference includes a vocabulary associated with initial training of a personalized TTS model.

Example 13 includes the device of Examples 11 or Example 12, wherein the reference includes at least a portion of one or more ASR transcriptions of one or more of the set of speech samples.

Example 14 includes the device of any of Examples 1 to 13, and further includes one or more microphones coupled to the one or more processors and configured to capture the one or more audio signals.

Example 15 includes the device of any of Examples 1 to 14, wherein the one or more processors are integrated in at least one of a mobile phone, a tablet computer device, a wearable electronic device, or a camera device, and wherein the mobile phone, the tablet computer device, the wearable electronic device, or the camera device is configured to perform the sequence of sample criteria checks.

Example 16 includes the device of any of Examples 1 to 15, wherein the one or more processors are integrated in a vehicle that is configured to perform the sequence of sample criteria checks.

Example 17 includes the device of any of Examples 1 to 16, wherein the one or more processors are configured to, prior to performance of the sequence of sample criteria checks: perform one or more noise reduction operations on the speech samples; perform a filtering process on the speech samples, wherein the filtering process includes: performance of user identification on the speech samples to identify the user speech and non-user speech; and filtering of the speech samples to remove one or more samples that include the non-user speech and do not include the user speech; or a combination thereof.

Example 18 includes the method of any of Examples 1 to 17, wherein the personalized TTS output is generated by a personalized TTS model at the device that is configured to mimic pronunciation of one or more test users.

According to Example 19, a method includes: obtaining, by one or more processors of a device during normal operation of the device, one or more audio signals that include user speech; and performing, by the one or more processors, a sequence of sample criteria checks on speech samples associated with the one or more audio signals, wherein the sequence of sample criteria checks includes: a check whether a confidence value associated with an automatic speech recognition (ASR) transcription of a sample exceeds a transcription confidence threshold; and a check whether a loss value associated with a personalized TTS output of the sample exceeds a loss threshold, the ASR transcription satisfies a lexicon diversity criterion, or both.

Example 20 includes the method of Example 19, and further includes, prior to performing the sequence of sample criteria checks: performing one or more noise reduction operations on the speech samples; performing a filtering process on the speech samples, wherein the filtering process includes: performing user identification on the speech samples to identify the user speech and non-user speech; and filtering the speech samples to remove one or more samples that include the non-user speech and do not include the user speech; or a combination thereof.

Example 21 includes the method of Example 19 or Example 20, wherein the personalized TTS output is generated by a personalized TTS model at the device that is configured to mimic pronunciation of one or more test users.

Example 22 includes the method of any of Examples 19 to 21, wherein the sequence of sample criteria checks is related to fitness of the speech samples for use in adapting a personalized TTS model at the device.

Example 23 includes the method of any of Examples 19 to 22, wherein, after performance of the sequence of sample criteria checks, the set of speech samples includes one or more speech samples of the speech samples that are associated with a corresponding confidence value that exceeds the transcription confidence threshold and that are associated with a corresponding loss value that exceeds the loss threshold or a corresponding ASR transcript that satisfies the lexicon diversity criterion.

Example 24 includes the method of any of Examples 19 to 23, wherein the sequence of sample criteria checks further includes a check whether a signal-to-noise ratio (SNR) value associated with the sample exceeds an SNR threshold, and wherein, after performance of the sequence of sample criteria checks, each speech sample of the set of speech samples is associated with a corresponding SNR value that exceeds the SNR threshold.

Example 25 includes the method of Example 24, and further includes: measuring the SNR value associated with the sample; and comparing the SNR value to the SNR threshold.

Example 26 includes the method of any of Examples 19 to 25, and further includes adapting a personalized TTS model based on the set speech of samples.

Example 27 includes the method of Example 26, and further includes adapting the personalized TTS model based on detection of a trigger condition associated with the device.

Example 28 includes the method of Example 27, wherein the trigger condition includes transition of the device to a sleep mode, detection of a target time of day, receipt of a user input associated with adapting the personalized TTS model, operation of the device in a low power operating mode for a threshold time period, detection of the device being connected to an external power source, or a combination thereof.

Example 29 includes the method of any of Examples 19 to 28, and further includes: performing one or more ASR operations on the sample to generate the ASR transcription and the confidence value, wherein the ASR transcription includes text data that represents the user speech included in the sample, and wherein the confidence value indicates a confidence that the text data matches the user speech; and comparing the confidence value to the transcription confidence threshold.

Example 30 includes the method of any of Examples 19 to 29, and further includes: providing the ASR transcription to a personalized TTS model to generate the personalized TTS output of the sample; generating the loss value based on a comparison of the personalized TTS output to the sample; and comparing the loss value to the loss threshold.

Example 31 includes the method of any of Examples 19 to 30, and further includes: comparing the ASR transcription to a reference; and determining whether the ASR transcription satisfies the lexicon diversity criterion based on the comparison.

Example 32 includes the method of Example 31, wherein the reference includes a vocabulary associated with initial training of a personalized TTS model.

Example 33 includes the method of Examples 31 or Example 32, wherein the reference includes at least a portion of one or more ASR transcriptions of one or more of the set of speech samples.

Example 34 includes the method of any of Examples 19 to 33, wherein the device includes one or more microphones coupled to the one or more processors and configured to capture the one or more audio signals.

Example 35 includes the method of any of Examples 19 to 34, wherein the device is at least one of a mobile phone, a tablet computer device, a wearable electronic device, or a camera device, and wherein the mobile phone, the tablet computer device, the wearable electronic device, or the camera device is configured to perform the sequence of sample criteria checks.

Example 36 includes the method of any of Examples 19 to 35, wherein the device is a vehicle that is configured to perform the sequence of sample criteria checks.

According to Example 37, a non-transitory, computer-readable medium storing instructions that are executable by one or more processors to cause the one or more processors to: obtain, during normal operation of a device, one or more audio signals that include user speech; and perform a sequence of sample criteria checks on speech samples associated with the one or more audio signals, wherein the sequence of sample criteria checks includes: a check whether a confidence value associated with an automatic speech recognition (ASR) transcription of a sample exceeds a transcription confidence threshold; and a check whether a loss value associated with a personalized text-to-speech (TTS) output of the sample exceeds a loss threshold, the ASR transcription satisfies a lexicon diversity criterion, or both.

Example 38 includes the non-transitory, computer-readable medium of Example 37, wherein the sequence of sample criteria checks is related to fitness of the speech samples for use in adapting a personalized TTS model at the device.

Example 39 includes the non-transitory, computer-readable medium of Example 37 or Example 38, wherein, after performance of the sequence of sample criteria checks, the set of speech samples includes one or more speech samples of the speech samples that are associated with a corresponding confidence value that exceeds the transcription confidence threshold and that are associated with a corresponding loss value that exceeds the loss threshold or a corresponding ASR transcript that satisfies the lexicon diversity criterion.

Example 40 includes the non-transitory, computer-readable medium of any of Examples 37 to 39, wherein the sequence of sample criteria checks further includes a check whether a signal-to-noise ratio (SNR) value associated with the sample exceeds an SNR threshold, and wherein, after performance of the sequence of sample criteria checks, each speech sample of the set of speech samples is associated with a corresponding SNR value that exceeds the SNR threshold.

Example 41 includes the non-transitory, computer-readable medium of Example 40, wherein the instructions are executable by the one or more processors to cause the one or more processors to: measure the SNR value associated with the sample; and compare the SNR value to the SNR threshold.

Example 42 includes the non-transitory, computer-readable medium of any of Examples 37 to 41, wherein the instructions are executable by the one or more processors to cause the one or more processors to adapt the personalized TTS model based on the set of speech samples.

Example 43 includes the non-transitory, computer-readable medium of Example 42, wherein the instructions are executable by the one or more processors to cause the one or more processors to adapt the personalized TTS model based on detection of a trigger condition associated with the device.

Example 44 includes the non-transitory, computer-readable medium of Example 43, wherein the trigger condition includes transition of the device to a sleep mode, detection of a target time of day, receipt of a user input associated with adapting the personalized TTS model, operation of the device in a low power operating mode for a threshold time period, detection of the device being connected to an external power source, or a combination thereof.

Example 45 includes the non-transitory, computer-readable medium of any of Examples 37 to 44, wherein the instructions are executable by the one or more processors to cause the one or more processors to: perform one or more ASR operations on the sample to generate the ASR transcription and the confidence value, wherein the ASR transcription includes text data that represents the user speech included in the sample, and wherein the confidence value indicates a confidence that the text data matches the user speech; and compare the confidence value to the transcription confidence threshold.

Example 46 includes the non-transitory, computer-readable medium of any of Examples 37 to 45, wherein the instructions are executable by the one or more processors to cause the one or more processors to: provide the ASR transcription to a personalized TTS model to generate the personalized TTS output of the sample; generate the loss value based on a comparison of the personalized TTS output to the sample; and compare the loss value to the loss threshold.

Example 47 includes the non-transitory, computer-readable medium of any of Examples 37 to 46, wherein the instructions are executable by the one or more processors to cause the one or more processors to: compare the ASR transcription to a reference; and determine whether the ASR transcription satisfies the lexicon diversity criterion based on the comparison.

Example 48 includes the non-transitory, computer-readable medium of Example 47, wherein the reference includes a vocabulary associated with initial training of a personalized TTS model.

Example 49 includes the non-transitory, computer-readable medium of Examples 47 or Example 48, wherein the reference includes at least a portion of one or more ASR transcriptions of one or more of the set of speech samples.

Example 50 includes the non-transitory, computer-readable medium of any of Examples 37 to 49, wherein the one or more processors are coupled to one or more microphones configured to capture the one or more audio signals.

Example 51 includes the non-transitory, computer-readable medium of any of Examples 37 to 50, wherein the one or more processors are integrated in at least one of a mobile phone, a tablet computer device, a wearable electronic device, or a camera device, and wherein the mobile phone, the tablet computer device, the wearable electronic device, or the camera device is configured to perform the sequence of sample criteria checks.

Example 52 includes the non-transitory, computer-readable medium of any of Examples 37 to 51, wherein the one or more processors are integrated in a vehicle that is configured to perform the sequence of sample criteria checks.

According to Example 53, an apparatus includes: means for obtaining, during normal operation of a device, one or more audio signals that include user speech; and means for performing a sequence of sample criteria checks on speech samples associated with the one or more audio signals, wherein the sequence of sample criteria checks includes: a check whether a confidence value associated with an automatic speech recognition (ASR) transcription of a sample exceeds a transcription confidence threshold; and a check whether a loss value associated with a personalized text-to-speech (TTS) output of the sample exceeds a loss threshold, the ASR transcription satisfies a lexicon diversity criterion, or both.

Example 54 includes the apparatus of Example 53, and further includes: means for performing, prior to performing the sequence of sample criteria checks, one or more noise reduction operations on the speech samples; means for performing a filtering process on the speech samples, wherein the filtering process includes: performing user identification on the speech samples to identify the user speech and non-user speech; and means for filtering the speech samples to remove one or more samples that include the non-user speech and do not include the user speech; or a combination thereof.

Example 55 includes the apparatus of Example 53 or Example 54, wherein the personalized TTS output is generated by a personalized TTS model at the device that is configured to mimic pronunciation of one or more test users.

Example 56 includes the apparatus of any of Examples 53 to 55, wherein the sequence of sample criteria checks is related to fitness of the speech samples for use in adapting a personalized TTS model at the device.

Example 57 includes the apparatus of any of Examples 53 to 56, wherein, after performance of the sequence of sample criteria checks, the set of speech samples includes one or more speech samples of the speech samples that are associated with a corresponding confidence value that exceeds the transcription confidence threshold and that are associated with a corresponding loss value that exceeds the loss threshold or a corresponding ASR transcript that satisfies the lexicon diversity criterion.

Example 58 includes the apparatus of any of Examples 53 to 57, wherein the sequence of sample criteria checks further includes a check whether a signal-to-noise ratio (SNR) value associated with the sample exceeds an SNR threshold, and wherein, after performance of the sequence of sample criteria checks, each speech sample of the set of speech samples is associated with a corresponding SNR value that exceeds the SNR threshold.

Example 59 includes the apparatus of Example 58, and further includes: means for measuring the SNR value associated with the sample; and means for comparing the SNR value to the SNR threshold.

Example 60 includes the apparatus of any of Examples 53 to 59, and further includes means for adapting a personalized TTS model based on the set speech of samples.

Example 61 includes the apparatus of Example 60, and further includes means for adapting the personalized TTS model based on detection of a trigger condition associated with the device.

Example 62 includes the apparatus of Example 61, wherein the trigger condition includes transition of the device to a sleep mode, detection of a target time of day, receipt of a user input associated with adapting the personalized TTS model, operation of the device in a low power operating mode for a threshold time period, detection of the device being connected to an external power source, or a combination thereof.

Example 63 includes the apparatus of any of Examples 53 to 62, and further includes: means for performing one or more ASR operations on the sample to generate the ASR transcription and the confidence value, wherein the ASR transcription includes text data that represents the user speech included in the sample, and wherein the confidence value indicates a confidence that the text data matches the user speech; and means for comparing the confidence value to the transcription confidence threshold.

Example 64 includes the apparatus of any of Examples 53 to 63, and further includes: means for providing the ASR transcription to a personalized TTS model to generate the personalized TTS output of the sample; means for generating the loss value based on a comparison of the personalized TTS output to the sample; and means for comparing the loss value to the loss threshold.

Example 65 includes the apparatus of any of Examples 53 to 64, and further includes: means for comparing the ASR transcription to a reference; and means for determining whether the ASR transcription satisfies the lexicon diversity criterion based on the comparison.

Example 66 includes the apparatus of Example 65, wherein the reference includes a vocabulary associated with initial training of a personalized TTS model.

Example 67 includes the apparatus of Examples 65 or Example 66, wherein the reference includes at least a portion of one or more ASR transcriptions of one or more of the set of speech samples.

Example 68 includes the apparatus of any of Examples 53 to 67, and further includes means for capturing the one or more audio signals.

Example 69 includes the apparatus of any of Examples 53 to 68, wherein the means for obtaining and the means for performing are integrated in at least one of a mobile phone, a tablet computer device, a wearable electronic device, or a camera device, and wherein the mobile phone, the tablet computer device, the wearable electronic device, or the camera device is configured to perform the sequence of sample criteria checks.

Example 70 includes the apparatus of any of Examples 53 to 69, wherein the means for obtaining and the means for performing are integrated in a vehicle that is configured to perform the sequence of sample criteria checks.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store a set of speech samples; and
one or more processors coupled to the memory, wherein the one or more processors are configured to:
obtain, during normal operation of the device, one or more audio signals that include user speech; and
perform a sequence of sample criteria checks on the speech samples associated with the one or more audio signals, wherein the sequence of sample criteria checks include:
a check whether a confidence value associated with an automatic speech recognition (ASR) transcription of a sample exceeds a transcription confidence threshold; and
a check whether a loss value associated with a personalized text-to-speech (TTS) output of the sample exceeds a loss threshold, the ASR transcription satisfies a lexicon diversity criterion, or both.

2. The device of claim 1, wherein the sequence of sample criteria checks is related to fitness of the speech samples for use in adapting a personalized TTS model at the device.

3. The device of claim 1, wherein, after performance of the sequence of sample criteria checks, the set of speech samples includes one or more speech samples that are associated with a corresponding confidence value that exceeds the transcription confidence threshold and that are associated with a corresponding loss value that exceeds the loss threshold or a corresponding ASR transcript that satisfies the lexicon diversity criterion.

4. The device of claim 1, wherein the sequence of sample criteria checks further includes a check whether a signal-to-noise ratio (SNR) value associated with the sample exceeds an SNR threshold, and wherein, after performance of the sequence of sample criteria checks, each speech sample of the set of speech samples is associated with a corresponding SNR value that exceeds the SNR threshold.

5. The device of claim 4, wherein the one or more processors are further configured to:
measure the SNR value associated with the sample; and
compare the SNR value to the SNR threshold.

6. The device of claim 1, wherein the one or more processors are further configured to adapt a personalized TTS model based on the set of speech samples.

7. The device of claim 6, wherein the one or more processors are further configured to adapt the personalized TTS model based on detection of a trigger condition associated with the device.

8. The device of claim 7, wherein the trigger condition includes transition of the device to a sleep mode, detection of a target time of day, receipt of a user input associated with adapting the personalized TTS model, operation of the device in a low power operating mode for a threshold time period, detection of the device being connected to an external power source, or a combination thereof.

9. The device of claim 1, wherein the one or more processors are further configured to:
perform one or more ASR operations on the sample to generate the ASR transcription and the confidence value, wherein the ASR transcription includes text data that represents the user speech included in the sample, and wherein the confidence value indicates a confidence that the text data matches the user speech; and
compare the confidence value to the transcription confidence threshold.

10. The device of claim 1, wherein the one or more processors are further configured to:
provide the ASR transcription to a personalized TTS model to generate the personalized TTS output of the sample;
generate the loss value based on a comparison of the personalized TTS output to the sample; and
compare the loss value to the loss threshold.

11. The device of claim 1, wherein the one or more processors are further configured to:
compare the ASR transcription to a reference; and
determine whether the ASR transcription satisfies the lexicon diversity criterion based on the comparison.

12. The device of claim 11, wherein the reference includes a vocabulary associated with initial training of a personalized TTS model.

13. The device of claim 11, wherein the reference includes at least a portion of one or more ASR transcriptions of one or more of the set of speech samples.

14. The device of claim 1, further comprising one or more microphones coupled to the one or more processors and configured to capture the one or more audio signals.

15. The device of claim 1, wherein the one or more processors are integrated in at least one of a mobile phone, a tablet computer device, a wearable electronic device, or a camera device, and wherein the mobile phone, the tablet computer device, the wearable electronic device, or the camera device is configured to perform the sequence of sample criteria checks.

16. The device of claim 1, wherein the one or more processors are integrated in a vehicle that is configured to perform the sequence of sample criteria checks.

17. A method comprising:
obtaining, by one or more processors of a device during normal operation of the device, one or more audio signals that include user speech; and
performing, by the one or more processors, a sequence of sample criteria checks on speech samples associated with the one or more audio signals, wherein the sequence of sample criteria checks include:
a check whether a confidence value associated with an automatic speech recognition (ASR) transcription of a sample exceeds a transcription confidence threshold; and
a check whether a loss value associated with a personalized text-to-speech (TTS) output of the sample exceeds a loss threshold, the ASR transcription satisfies a lexicon diversity criterion, or both.

18. The method of claim 17, further comprising, prior to performing the sequence of sample criteria checks:
performing one or more noise reduction operations on the speech samples;
performing a filtering process on the speech samples, wherein the filtering process includes:
performing user identification on the speech samples to identify the user speech and non-user speech; and
filtering the speech samples to remove one or more samples that include the non-user speech and do not include the user speech; or
a combination thereof.

19. The method of claim 17, wherein the personalized TTS output is generated by a personalized TTS model at the device that is configured to mimic pronunciation of one or more test users.

20. A non-transitory, computer-readable medium storing instructions that are executable by one or more processors to cause the one or more processors to:
obtain, during normal operation of a device, one or more audio signals that include user speech; and
perform a sequence of sample criteria checks on speech samples associated with the one or more audio signals, wherein the sequence of sample criteria checks include:
a check whether a confidence value associated with an automatic speech recognition (ASR) transcription of a sample exceeds a transcription confidence threshold; and
a check whether a loss value associated with a personalized text-to-speech (TTS) output of the sample exceeds a loss threshold, the ASR transcription satisfies a lexicon diversity criterion, or both.
